(19) United States
(12) Patent Application Publication
(10) Pub. No.: US 2015/0331568 A1
(43) Pub. Date: Nov. 19, 2015

(54) PROGRAM AND ELECTRONIC-MANUAL DISPLAY APPARATUS

(71) Applicants: Koji AMANO, Tokyo (JP); Hikaru SAKATA, (US); Satoshi UDO, Tokyo (JP)

(72) Inventors: Koji AMANO, Tokyo (JP); Satoshi UDO, Tokyo (JP); Hikaru SAKATA, Tokyo (JP)

(73) Assignee: MITSUBISHI ELECTRIC CORPORATION, Tokyo (JP)

(21) Appl. No.: 14/442,614

(22) PCT Filed: Jan. 25, 2013
(86) PCT No.: PCT/JP2013/051582

§ 371 Date: May 13, 2015

(51) Int. Cl. G06F 3/0484; H04L 29/08; G06F 17/30

(52) U.S. Cl. CPC G06F 3/0484; G06F 17/30864; H04L 67/32

(57) ABSTRACT

To easily and clearly display contents desired by a user from among an electronic manual group, an electronic-manual displaying device, when receiving an input designating a product from the user (step S11), automatically specifies an electronic manual folder, an explanation target of which is the product (step S12 to step S14); and, when a plurality of the specified electronic manual folders are present, it displays, on a manual display screen, manuals on the basis of the manual structure data stored in the specified electronic manual folders (step S16).

### FIELD

The present invention relates to a program and an electronic-manual display apparatus that displays a digitized user manual.

### BACKGROUND

Conventionally, user operation manuals (a manual) for a product are provided in printed form or electronic data form (an electronic manual). Furthermore, an FA system is configured, for example, from a large number of products. The individual products from which an FA system is configured generally have a large number of functions. Information concerning one product is sometimes mentioned in separate volumes of a plurality of manuals. For these reasons, when designing an FA system, a user will often possess a large number of manuals. There is a problem in that extracting the desired information from such a number of manuals imposes a heavy work load on the user.

Patent Literature 1, for example, discloses a technology related to this problem in which electronic manuals are related to each other by using relational information in which links to the electronic manuals are given. By using this technology, the user can display, from one electronic manual, another electronic manual that is already associated with the first electronic manual. Further, by using related information, the user can search the electronic manuals using the same keyword at the same time.

### CITATION LIST

### Patent Literature

Patent Literature 1: Japanese Patent Application Laid-Open No. 2003-271662

### SUMMARY

### Technical Problem

As described above, the products used in an FA system are various, and one product has a large number of functions. Consequently, even if the technology disclosed in Patent Literature 1 is used, the task of identifying electronic manuals according to functions and product types is still necessary, and therefore there is still a problem in that the searchability of the electronic manuals is poor.

The present invention has been made in view of the above and it is an objective of the present invention to provide a program and an electronic-manual display apparatus that can easily and clearly display the content desired by a user from among an electronic manual group.

### Solution to Problem

In order to solve the problems and achieve the objective, one aspect of the present invention relates to a program that causes a computer including a storage device to execute: a step of registering, in the storage device, data of a plurality of electronic manuals, each including text data of a product manual, the electronic manual data including attribute information in which, for each product that is an explanation target of the electronic manual data, a correspondence relation between the product and a group ID is recorded; a step of receiving, from an outside source, a first input for designating a product; a step of extracting a group ID associated with the designated product from the attribute information in the electronic manual data stored in the storage device; a step of specifying the electronic manual data including the attribute information in which the extracted group ID is recorded; a step of displaying, when data of one electronic manual is specified, in a first region of a display device, text data included in the specified electronic manual data; and a step of connecting, when data of a plurality of electric manuals is specified, text data included in the specified electronic manual data and displaying the text data in the first region.

### Advantageous Effects of Invention

A computer that executes a program according to the present invention can omit the task of specifying the electronic manual data on the product desired by a user from among electronic manual data. Therefore, it is possible to easily display the content desired by the user that is among an electronic manual group. Further, with the computer that executes the program according to the present invention, when electronic manual data is specified, text data related to the specified electronic manual data is displayed in association with one another in the first region of the output device. Therefore, it is possible to improve visibility compared with a case where different items of data are respectively displayed on different screens. That is, with the program according to the present invention, it is possible to clearly display the content desired by the user from among the electronic manual group.

### BRIEF DESCRIPTION OF DRAWINGS

FIG. 1 is a diagram illustrating a configuration of an electronic-manual display apparatus in a first embodiment.

FIG. 2 is a diagram explaining a display screen example. FIG. 3 is a diagram explaining a display screen example.

FIG. 4 is a diagram explaining a display screen example.

FIG. 5 is a diagram explaining the configuration of an electronic manual folder.

FIG. 6 is a diagram illustrating an example of manual structure data and a display example of manuals.

FIG. 7 is a diagram explaining a data structure example of attribute information.

FIG. 8 is a diagram explaining a data structure example of illustration table-of-contents information.

FIG. 9 is a diagram explaining a data structure example of product illustration link information.

FIG. 10 is a diagram explaining content included in a traverse management database.

FIG. 11 is a diagram explaining a data structure example of a supervision table.

FIG. 12 is a diagram explaining a data structure example of a combination table.

FIG. 13 is a diagram explaining the data structure of a classification management table.

FIG. 14 is a diagram explaining a data structure example of an illustration supervision table.

FIG. 15 is a diagram explaining a data structure example of a version management table.

FIG. 16 is a diagram explaining content included in a database with respect to a manual.

FIG. 17 is a diagram explaining a data structure example of a search table in the first embodiment.

FIG. 18 is a flowchart explaining the registration process of an electronic manual.

FIG. 19 is a flowchart explaining the operation of the electronic-manual display apparatus performed when an input for designating a type name is received from a product-tree display screen.

FIG. 20 is a flowchart explaining the operation of the electronic-manual display apparatus performed when system configuration information is input.

FIG. 21 is a flowchart explaining the operation of the electronic-manual display apparatus when displaying an image of a product.

FIG. 22 is a flowchart explaining the operation of the electronic-manual display apparatus performed when an input for selecting a draw-out line is received.

FIG. 23 is a flowchart explaining the operation of the electronic-manual display apparatus during a search.

FIG. 24 is a flowchart explaining the operation of the electronic-manual display apparatus performed when registration of a position on a manual display as a bookmark is input.

FIG. 25 is a flowchart explaining the operation of the electronic-manual display apparatus when an electronic manual folder is being updated to the latest version.

FIG. 26 is a diagram explaining a data structure example of a search table in a second embodiment.

FIG. 27 is a flowchart explaining the operation of an engineering tool.

FIG. 28 is a flowchart explaining the operation of an electronic-manual display apparatus performed when a display request is received.

### DESCRIPTION OF EMBODIMENTS

Exemplary embodiments of the present invention are described in detail below with reference to the drawings. Note that the present invention is not limited to the embodiments.

### First Embodiment

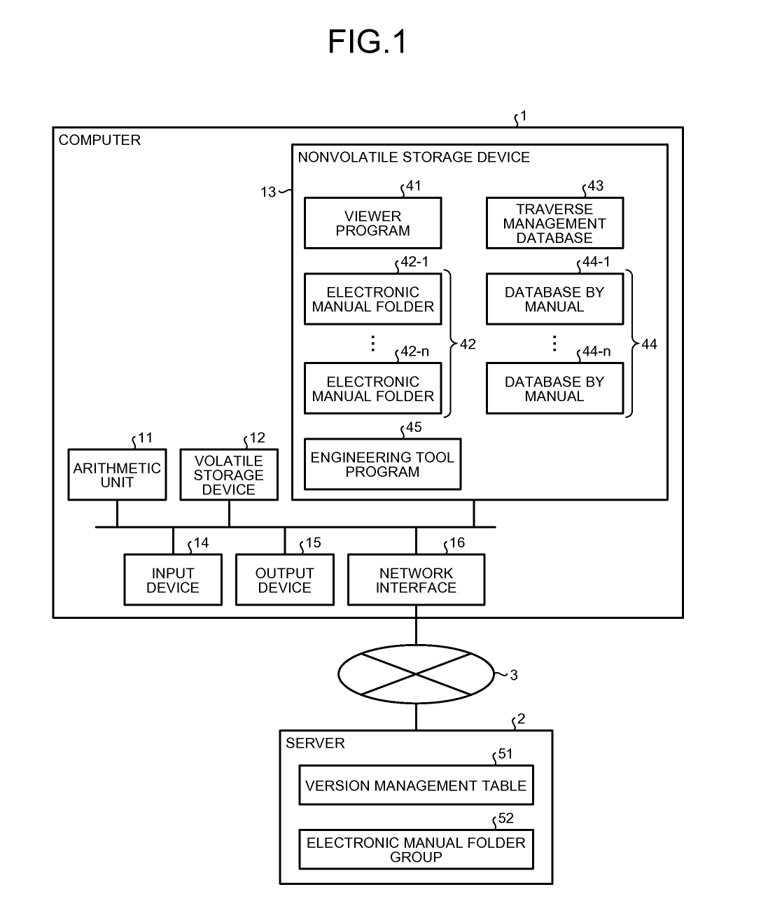

FIG. 1 is a diagram illustrating the configuration of an electronic-manual display apparatus according to a first embodiment of the present invention.

The electronic-manual display apparatus is realized by a computer 1 including an arithmetic unit 11, a volatile storage device 12, a nonvolatile storage device (a storage device) 13, an input device 14, an output device (a display device) 15, and a network interface 16. The arithmetic unit 11, the volatile storage device 12, the nonvolatile storage device 13, the input device 14, the output device 15, and the network interface 16 are connected to one another via a bus line.

The computer 1 is connectable to a server 2 via a network 3. The network 3 is wired, wireless, or a combination of the two. The communication standard of the network 3 is not limited to a specific standard. The timing with which the computer 1 is connected to the server 2 can be any timing. The computer 1 is capable of functioning as, in a standalone state, the electronic-manual display apparatus in the embodiment of the present invention and executing operations excluding the registration process explained below.

The network interface 16 is a connection device for connecting the computer 1 to the network 3. The output device 15 is, for example, a liquid crystal monitor and is a device capable of displaying various screens. The output device 15 displays a screen generated by the arithmetic unit 11. The input device 14 includes, for example, a pointing device (e.g., a mouse) and a keyboard. Operation input to the computer 1 from the user is input to the input device 14. The input operation information is sent to the arithmetic unit 11.

The arithmetic unit 11 is a processor that operates in accordance with a program. The volatile storage device 12 is, in general, a memory accessible at a higher speed than the nonvolatile storage device 13 and is, for example, a RAM (Random Access Memory). The volatile storage device 12 is used as a region where the program for controlling the arithmetic unit 11 is expanded or a work area of the arithmetic unit 11.

The nonvolatile storage device 13 is configured from, for example, a ROM (Read Only Memory), a HDD (Hard Disk Drive), an SSD (Solid State Drive), a CD-ROM, a DVD-ROM, a detachable memory device, or a combination of the forgoing. The nonvolatile storage device 13 functions as a recording medium that stores in advance the program for controlling the arithmetic unit 11. Note that, any recording medium, other than those described above, that stores in advance the program for controlling the arithmetic unit 11 is applicable as long as the recording medium is a non-transitory tangible recording medium. The nonvolatile storage device 13 stores data used by the program.

Specifically, the nonvolatile storage device 13 stores in advance a viewer program 41, which is the program in the embodiment of the present invention, a plurality of (n) electronic manual folders (electronic manual data) 42-1 to 42-n, a traverse management database 43, n databases as manuals 44-1 to 44-n, respectively corresponding to the electronic manual folders 42-1 to 42-n, and an engineering tool program 45.

The arithmetic unit 11 reads out the viewer program 41 from the nonvolatile storage device 13 and expands the viewer program 41 in the program expansion region of the volatile storage device 12. The arithmetic unit 11 executes various kinds of processing of the electronic-manual display apparatus in the embodiment of the present invention in accordance with control performed by the viewer program 41 expanded in the program expansion region. Note that, in the following description, the computer 1 operating in accordance with the viewer program 41 is referred to as electronic-manual display apparatus 1.

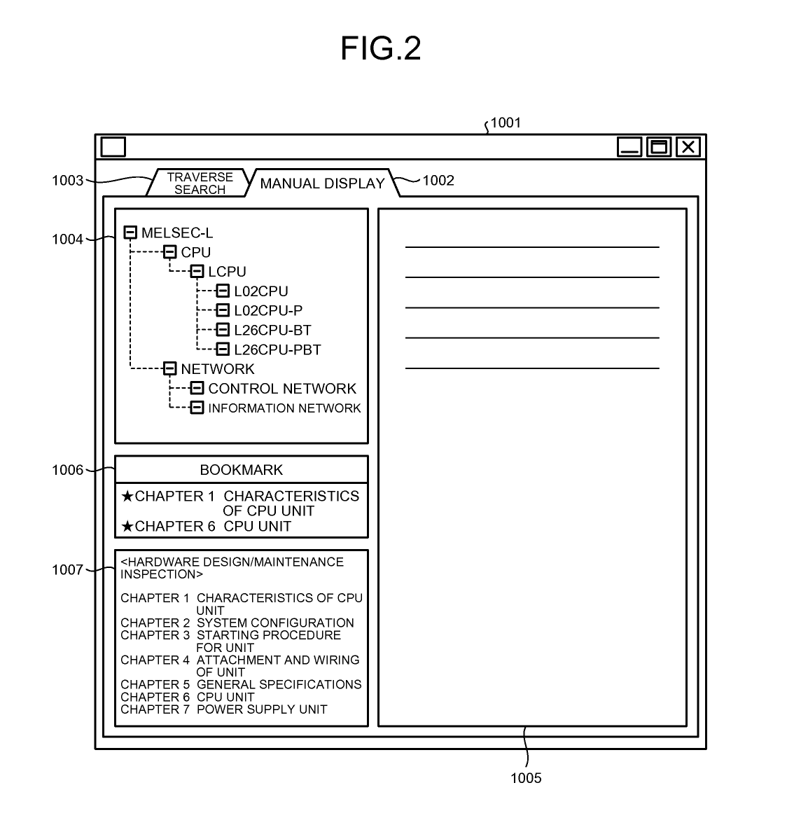

A display screen displayed on the output device 15 in accordance with the viewer program 41 is described here. FIGS. 2 to 4 are diagrams explaining display screen examples. A viewer screen 1001 is displayed on the output device 15. The viewer screen 1001 includes a manual display tab 1002 and a traverse search tab 1003. The viewer screen 1001 can switch and display, according to a selection made by the user, screens respectively associated with the tabs.

When the manual display tab 1002 is selected, as illustrated in FIG. 2, a manual display screen (a first region and a third region) 1005, a product-tree display screen (a second region) 1004, a bookmark display screen (a fifth region) 1006, and a table-of-contents display screen (a fourth region) 1007 are displayed on the viewer screen 1001. The manual display screen 1005 is a region where an electronic manual is displayed. The product-tree display screen 1004 is a region where a list of type names of products capable of displaying an electronic manual is displayed. On the product-tree display screen 1004, the list of the type names is classified into series names, unit names, and model names and is displayed as a tree. The series name, the unit name, the model name, and the type name are distinct names for classifying products, respectively. The series name is a top category. The series name, the unit name, the model name, and the type name are disposed in a descending order of categories they appear in this sentence. Note that the series name is a name for specifying a product group having the same standard or concept among a unit group of the products. The unit name is a name for classifying models of the products by approximate functions. As the unit name, there is, for example, a CPU unit or a power supply unit. The model name is a name given to each function in the same unit. The type name is a name given to distinguish slight differences, such as different versions of the same model name. Note that the number of categories or definitions of categories is not limited to the above. The table-of-contents display screen 1007 is a region where a table of contents of an electronic manual is displayed. When the user performs an input for designating a desired type name on the product-tree display screen 1004 using the pointing device, the electronic-manual display apparatus 1 displays an electronic manual related to a product having the designated type name on the manual display screen 1005 and displays a table of contents of the electronic manual related to the product having the designated type name on the table-of-contents display screen 1007.

The electronic-manual display apparatus 1 divides an electronic manual related to a unit configuring an FA system into a plurality of electronic manuals and stores the electronic manuals (the electronic manual folders 42-1 to 42-n). That is, an electronic manual concerning a unit having one type name is sometimes divided into a plurality of electronic manuals and stored. Each of the electronic manual folders 42-1 to 42-n may sometimes include units of one or more type name as targets to be explained. According to the embodiment of the present invention, when an electronic manual related to a product having a designated type name is divided into a plurality of electronic manuals, the divided electronic manuals can be combined and displayed on the manual display screen 1005. Tables of contents of the divided electronic manuals can be connected and displayed on the table-of-contents display screen 1007.

Note that, on the manual display screen 1005, as illustrated in FIG. 3, an illustration of a product having a designated type name can be displayed. An illustration 1008 is displayed on the manual display screen 1005. On the illustration 1008, one or more regions of attention 1009 are respectively surrounded by dotted lines and displayed. The respective regions of attention 1009 are associated with short explanatory notes 1011 via draw-out lines 1010. When the user performs, using the pointing device, an input for selecting the draw-out line 1010 or the region of attention 1009 or the explanatory node 1011 associated with the draw-out line 1010, the electronic-manual display apparatus 1 can display an electronic manual corresponding to the directly or indirectly selected draw-out line 1010 on the manual display screen 1005. Note that a partial region in claims is a concept including the region of attention 1009, the draw-out line 1010, and the explanatory note 1011.

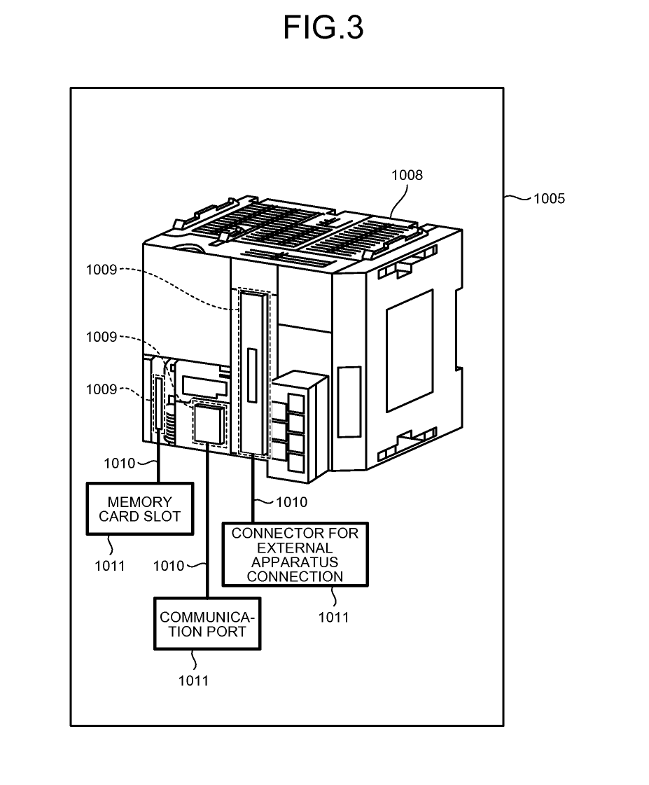

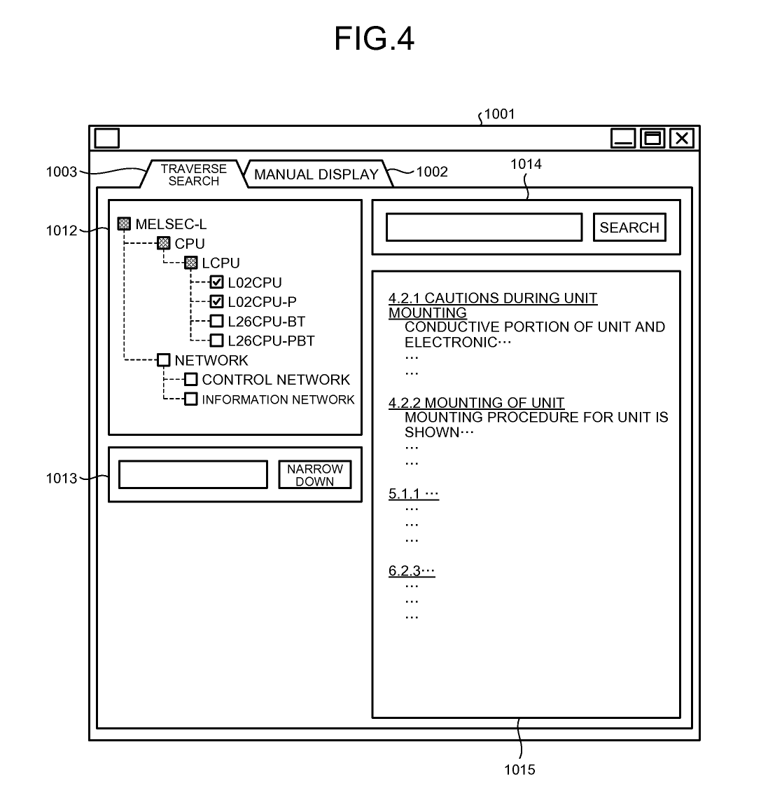

When the traverse search tab 1003 is selected, as illustrated in FIG. 4, a product-selection input screen (a second region) 1012, a keyword input screen 1013, a search-word input screen 1014, and a search-result display screen 1015 are displayed on the viewer screen 1001. The product-selection input screen 1012 is a region where a list of type names of products capable of displaying electronic manuals is displayed. On the product-selection input screen 1012, like the product-tree display screen 1004, a list of type names is classified into a series name, a unit name, and a model name and displayed as a tree. The product-selection input screen 1012 includes a checkbox for each classification. An input designating one or more type names desired by the user can be received in the checkbox of each of the type names or each of the classifications higher in order than the type names. The keyword input screen 1013 can receive an input of a keyword. The user can designate a search range of an electronic manual by performing any one of an input for designating a type name on the product-selection input screen 1012 and an input of a keyword on the keyword input screen 1013 or both. The search-word input screen 1014 can receive an input of a search word. The electronic-manual display apparatus 1 searches for a text body in the designated search range using, as a search key, the search word input via the search-word input screen 1014. The search-result display screen 1015 is a region where a search result is displayed. On the search-result display screen 1015, a found text body is abbreviated and displayed by, for example, reducing the length of a sentence for each heading.

Note that the layout and the sizes of the display screens 1004 to 1007 and 1012 to 1015 are not limited to by what are described above. Each of the display screens 1004 to 1007 and 1012 to 1015 can be displayed integrally with any display screen among the display screens 1004 to 1007 and 1012 to 1015. The display screens are switched by the traverse search tab 1003 and the manual display tab 1002. However, all of the display screens 1004 to 1007 and 1012 to 1015 can be displayed at the same time on the viewer screen 1001. The display screens 1004 to 1007 and 1012 to 1015 can be switched by three or more tabs and displayed. A part or all of the display screens 1004 to 1007 and 1012 to 1015 can be configured to be capable of being hidden or invoked by operations performed by the user. For example, the product-tree display screen 1004 and the product-selection input screen 1012 can be realized as the same screen. The screen on which the electronic manual is displayed and the screen on which the illustration 1008 is displayed can be divided into different screens.

The arithmetic unit 11 expands the engineering tool program 45 in the program expansion region according to a procedure that is the same as the procedure for executing the viewer program 41 stored by the nonvolatile storage device 13. The arithmetic unit 11 executes various kinds of processing of an engineering tool (a setting tool) in accordance with control performed by the expanded engineering tool program 45.

The engineering tool means a device that performs setting of a programmable logic controller (PLC) in accordance with an input from the user. The PLC is a control system that can control a controlled apparatus. In one example, the PLC is configured by mounting a power supply unit, a CPU unit, and a unit for assisting the CPU unit on a base unit, which is a backplane. A plurality of assisting units can be mounted on the base unit. The power supply unit supplies electric power to the various units from which the PLC is configured. The CPU unit stores, in an internal memory, a user program and one or more state variables (devices) related to the controlled apparatus. The respective devices are associated with memory addresses in the PLC in a one to one relation. The PLC operates values (device values) of the state variables in accordance with the user program. Various types, depending on their functions, of assisting units are present. For example, an analog unit that outputs an analog signal command to the controlled apparatus and receives an input of an analog signal response from the controlled apparatus that corresponds to the assisting unit. A temperature control unit generates a temperature control signal according to a temperature detection value from a temperature sensor and outputs the temperature control signal, which also corresponds to the assisting unit. The assisting units from which the PLC is configured are selected according to which function the user uses the PLC to realize. The assisting unit outputs an output signal to the controlled apparatus that has been predetermined and writes an input signal from the controlled apparatus in the predetermined device. The engineering tool can set up a user program in the CPU unit, define a unit configuration of the PLC, and define a use region of the device for each of the assisting units.

The electronic manual folders 42-1 to 42-n are each digitized product user manuals (electronic manual data). Note that any one of the electronic manual folders 42-1 to 42-n is sometimes referred to as electronic manual folder 42. An electric manual can explain one or more models.

Note that the server 2 is a computer including a storage device, an arithmetic unit, and a network interface. The server 2 (or more accurately, the storage device of the server 2) has stored therein an electronic manual folder group 52. The electronic manual folders 42-1 to 42-n are downloaded from the electronic manual folder group 52 stored by the server 2 via the network 3. The electronic-manual display apparatus 1 can download the electronic manual folder 42 of the latest version by accessing the server 2.

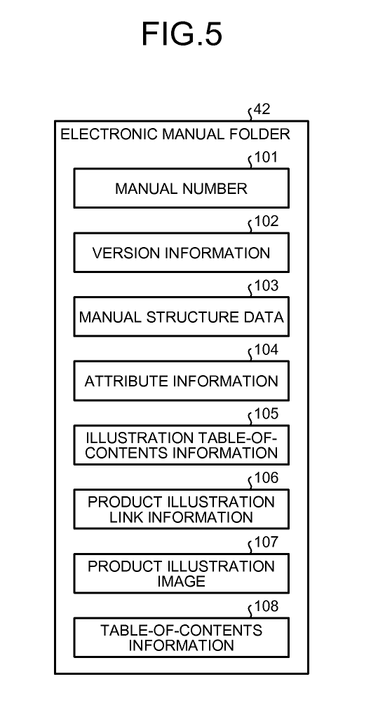

FIG. 5 is a diagram explaining the configuration of the electronic manual folder 42. As illustrated in the figure, the electronic manual folder 42 includes a manual number 101 and version information 102. The manual number 101 is identification information for identifying the respective electronic manual folders 42. The version information 102 is updated (e.g., incremented) to a new value every time the electronic manual folder 42 is updated. Note that, when the electronic manual folder 42 is updated, the manual number 101 is not updated.

The electronic manual folder 42 includes manual structure data (text data) 103.

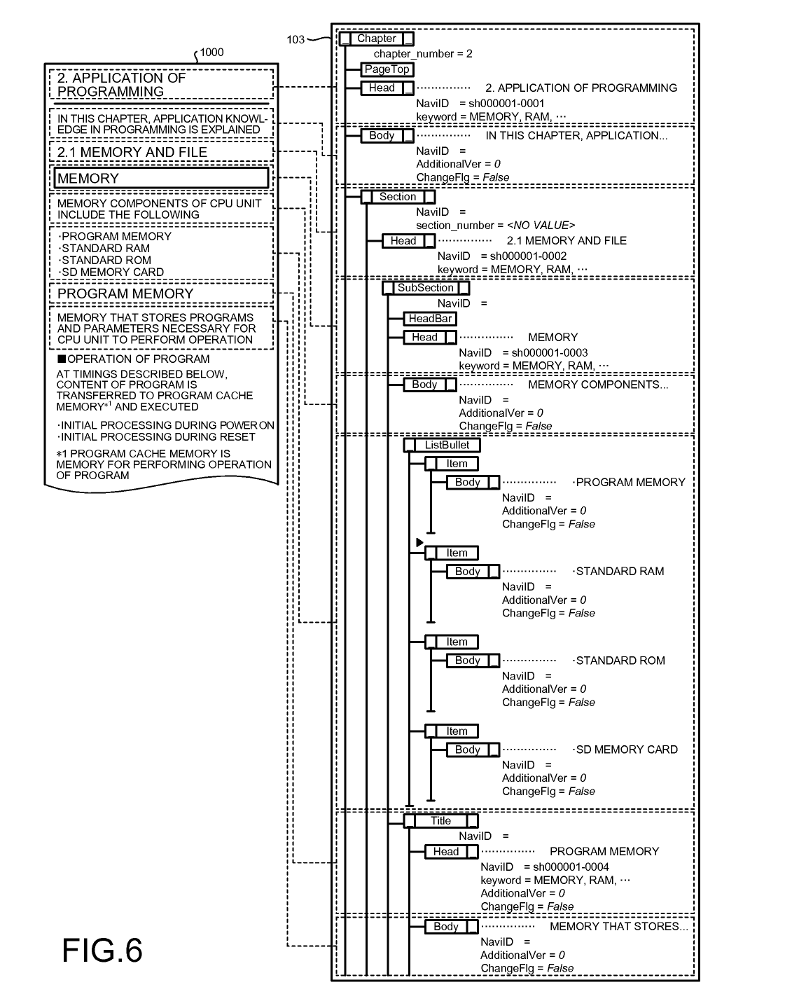

FIG. 6 is a diagram illustrating an example of the manual structure data 103 and a display example of a manual displayed when the manual structure data 103 is original data. The electronic-manual display apparatus 1 can display manual display 1000 illustrated in the left figure on the manual display screen 1005 by decoding the manual structure data 103 illustrated in the right figure. The manual structure data 103 includes control codes (“Chapter”, “Section”, “Subsection”, and “Title”) for specifying headings, a control code (“Body”) for providing a field in which a text body is written, and a control code (“Head”) provided for each of the headings. The “Head” records therein the display content of a heading, a navigation ID (Navi ID) functioning as a position control code, and a keyword (“keyword”).

The Navi ID is an exclusive identification number in a range of all the electronic manual folders 42 given to the “Head” and is used as position information. That is, the Navi ID is recorded in the manual structure data 103 for each predetermined unit. It is assumed here that the Navi ID is recorded for each “Head” provided for each of the headings. A keyword described in the “Head” is used by an application for narrowing down search-target text bodies. The keyword is permitted to be redundantly recorded among a plurality of the “Heads”. Note that the Navi ID or the keyword can be recorded in a place other than the “Head”. However, the electronic-manual display apparatus 1 does not recognize the Navi ID and the keyword recorded in the place other than the “Head”.

Note that, in this specification, the range of all the electronic manual folders 42 means a range including not only the electronic manual folders 42-1 to 42-1 stored by the nonvolatile storage device 13 but also electronic manual folders having the manual number 101 that are different from the manual number 101 of the electronic manual folders 42-1 to 42-n in the electronic manual folder group 52 stored in the server 2. The Navi ID is configured by combining the manual number 101 and a number (e.g., a number given as a serial number from the top) peculiar to one manual, which is a number allocated to each “Head”. That is, the Navi ID includes the manual number 101 in a part thereof.

The electronic manual folder 42 includes attribute information 104 indicating a type name of a product that is an explanation target of the electronic manual folder 42. The attribute information 104 is used to combine and display a plurality of electronic manuals.

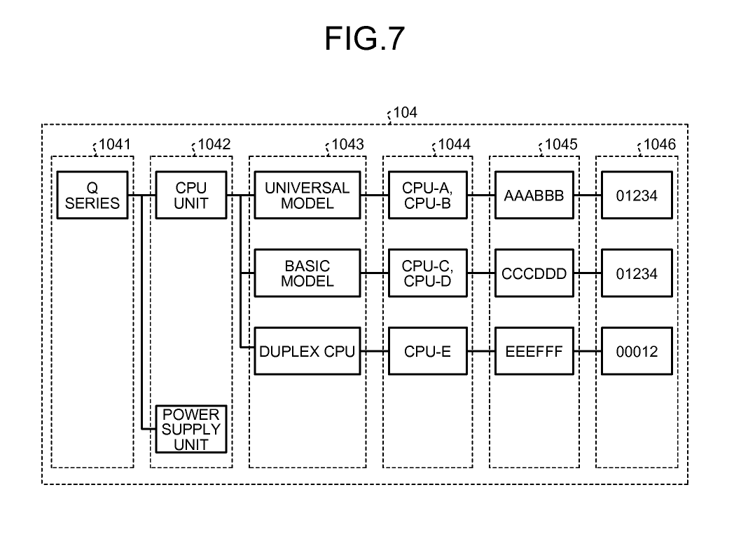

FIG. 7 is a diagram explaining a data structure example of the attribute information 104. As illustrated in the figure, the attribute information 104 includes, for each type name of an explanation-target product; an item 1041 in which a series name is described; an item 1042 in which a unit name is described; an item 1043 in which a model name is described; an item 1044 in which a type name is described; an item 1045 in which a separate volume group ID is described; and an item 1046 in which a separate volume listing order (a connection number) is described. The attribute information 104 indicates, for each type name, a series name, a unit name, and a model name to which a product belongs.

The separate volume group ID (a group ID) is identification information for specifying a combination-target of one piece or more of manual structure data 103. That is, the same separate volume group ID is permitted to be used among any two or more electronic manual folders 42 across the range of all the electronic manual folders 42. Note that, in the example illustrated in FIG. 7, the same separate volume group ID is given to a product of the same model name. However, the same ID does not have to be given to the separate volume group ID for each model name. The separate volume group ID can be different for each type name. The separate volume listing order is a value indicating, when the electronic manuals in a plurality of electronic manuals are combined, in which order the respective electronic manuals are actually combined.

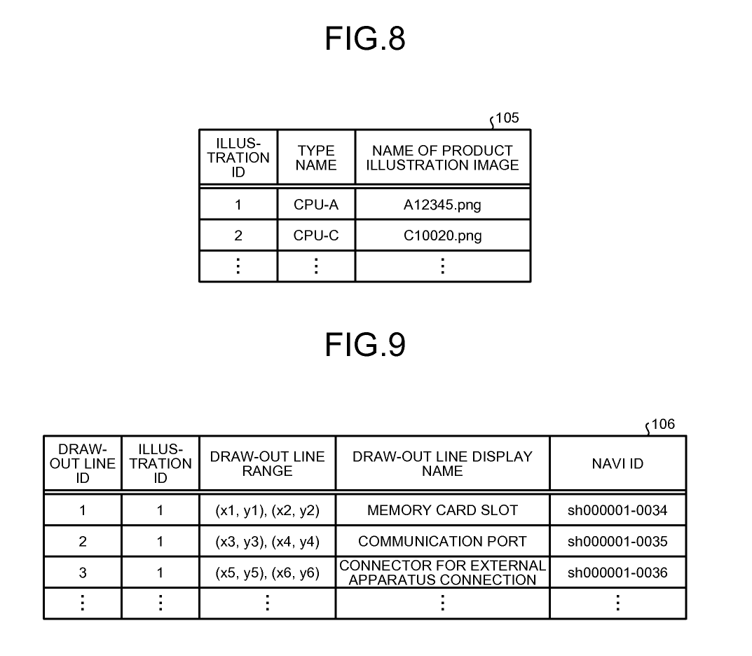

The electronic manual folder 42 includes illustration table-of-contents information 105, product illustration link information 106, a product illustration image 107, and table-of-contents information 108. The product illustration image 107 is image data of an illustration displayed on the manual display screen 1005. When there are a plurality of type names that the electronic manual folder 42 describes, the product illustration image 107 is retained in the electronic manual folder 42 for each of the type names. Note that the electronic manual folder 42 may also not retain the product illustration image 107. The illustration table-of-contents information 105 is a table in which the correspondence relation between a type name and an identification name of the product illustration image 107 is recorded as illustrated in FIG. 8. Note that an illustration ID illustrated in FIG. 8 is an ID for identifying respective entries registered in the illustration table-of-contents information 105 and is an ID peculiar to the electronic manual folders 42 that include the illustration table-of-contents information 105. The product illustration link information 106 is a table in which a correspondence relation among the draw-out line 1010, the region of attention 1009 (a draw-out line region), the explanatory note 1011, and the illustration ID is recorded for each of the draw-out lines 1010 as illustrated in FIG. 9. Entries included in the product illustration link information 106 are associated with the product illustration image 107 and the type name via the illustration ID, respectively. Note that a draw-out line ID illustrated in FIG. 9 is an ID for identifying the respective entries registered in the product illustration link information 106 and is an ID peculiar to the electronic manual folders 42 that include the product illustration link information 106. In the table-of-contents information 108, a table of contents included in the electronic manual folder 42 is recorded. The configuration of the table of contents described in the table-of-contents information 108 can be any configuration. However, the table of contents is configured by, for example, listing headings for each “Chapter” and each “Section”.

Note that, as described above, electronic manual data is described as being configured by storing a plurality of kinds of information (the manual number 101, the version information 102, the manual structure data 103, the attribute information 104, the illustration table-of-contents information 105, the product illustration link information 106, the product illustration image 107, and the table-of-contents information 108) in a folder. However, the configuration of the electronic manual data is not limited to the above. For example, the electronic manual data can be configured by collecting these kinds of information in one set of data.

The traverse management database 43 is a database for collectively managing the electronic manual folders 42-1 to 42-n. The electronic-manual display apparatus 1 updates the traverse management database 43 when the electronic manual folder 42 is added, deleted, or updated to a new version.

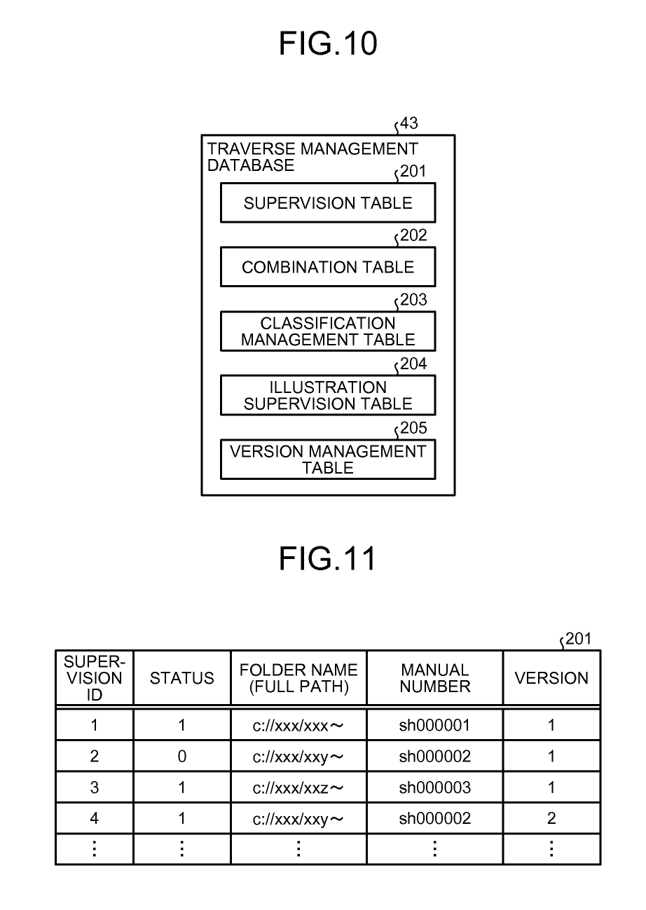

FIG. 10 is a diagram explaining the content included in the traverse management database 43. As illustrated in the figure, the traverse management database 43 includes a supervision table 201, a combination table 202, a classification management table 203, an illustration supervision table 204, and a version management table 205.

FIG. 11 is a diagram explaining a data structure example of the supervision table 201. The supervision table 201 is a table in which a correspondence relation among a folder name of the electronic manual folder 42, a manual number, and a version is recorded concerning all the electronic manual folders 42 stored in the electronic-manual display apparatus 1. The folder name of the electronic manual folder 42 is registered in a form of a full path and is also used as information for specifying (a storage position of) the electronic manual folder 42. In a field of the manual number and a field of the version of the supervision table 201, the manual number 101 and the version information 102 included in the electronic manual folder 42 are registered. Each of the entries is associated with a field in which a supervision ID is stored and a field in which a status is stored. The supervision ID is an ID for identifying the respective entries registered in the supervision table 201. The status is information indicating whether the respective entries are valid or invalid. A status of “1” indicates a valid entry and a status of “0” indicates an invalid entry.

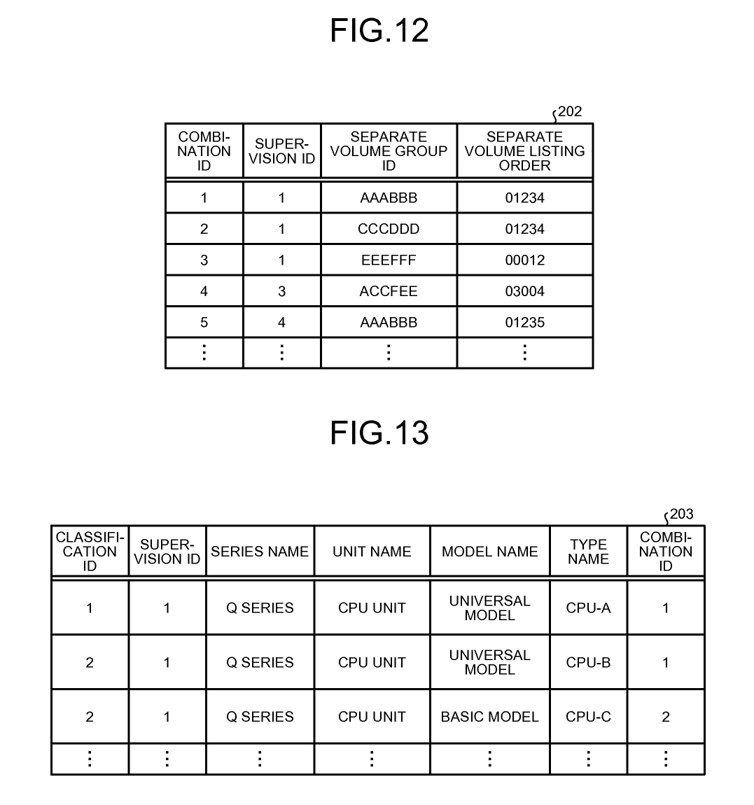

FIG. 12 is a diagram explaining a data structure example of the combination table 202. The combination table 202 is a table in which a correspondence relation between a separate volume group ID and separate volume listing order is recorded concerning all the electronic manual folders 42 stored in the electronic-manual display apparatus 1. The entry in the combination table 202 is associated with the electronic manual folder 42 via a supervision ID. Note that a combination ID is an ID for identifying the respective entries registered in the combination table 202.

FIG. 13 is a diagram explaining a data structure example of the classification management table 203. The classification management table 203 is a table in which a series name, a unit name, and a model name to which a product belongs are recorded for each type name. Entries in the classification management table 203 are associated with, via a combination ID, the entries (in particular, the separate volume group ID and the separate volume listing order) registered in the combination table 202. The entries in the classification management table 203 are associated with the electronic manual folder 42 via a supervision ID. Note that a classification ID is an ID for identifying the respective entries registered in the classification management table 203.

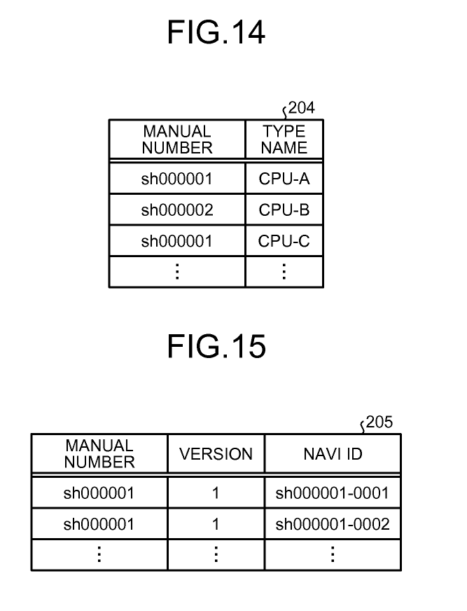

FIG. 14 is a diagram explaining a data structure example of the illustration supervision table 204. The illustration supervision table 204 is a table in which a correspondence relation between a type name and the manual number 101 of the electronic manual folder 42, which retains the product illustration image 107 of the type name, is recorded.

FIG. 15 is a diagram explaining a data structure example of the version management table 205. The version management table 205 is a table in which a correspondence relation between the manual number 101 and the version information 102 is recorded for each Navi ID.

Note that the server 2 also stores a version management table 51 having a data structure the same as the data structure of the version management table 205. That is, the version management table 51 is a table in which a correspondence relation between the manual number 101 and the version information 102 is recorded for each Navi ID concerning the electronic manual folder group 52. The electronic-manual display apparatus 1 can determine, by comparing the version management table 205 stored by the apparatus 1 and the version management table 51 stored by the server 2, whether the electronic manual folder 42 stored by the apparatus 1 is the latest version.

Each of the individual manual databases 44-1 to 44-n is a database for managing the electronic manual folder 42 corresponding thereto. Note that any one of the individual manual databases 44-1 to 44-n is sometimes referred to as the individual manual database 44.

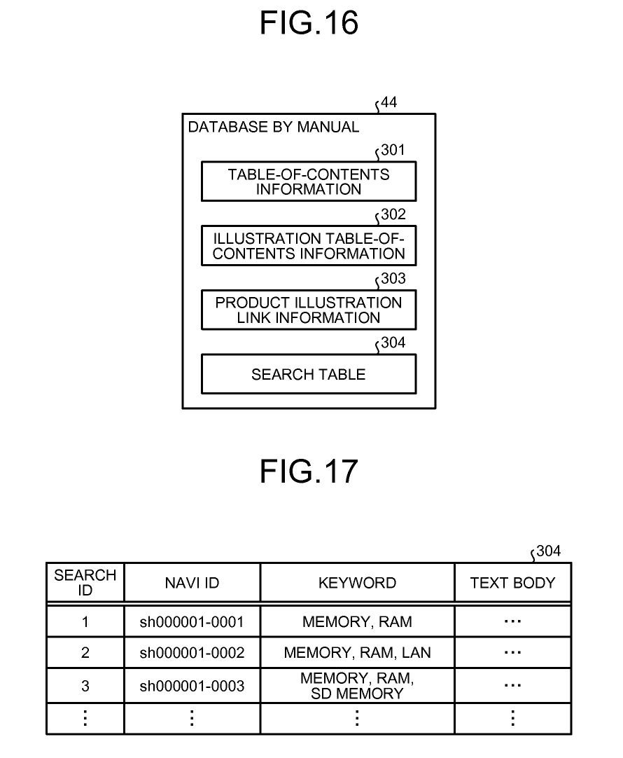

FIG. 16 is a diagram explaining content included in the individual manual databases 44. The individual manual databases 44 include table-of-contents information 301, illustration table-of-contents information 302, product illustration link information 303, and a search table 304. In the content included in the individual manual databases 44, the table-of-contents information 301, the illustration table-of-contents information 302, and the product illustration link information 303 are duplicates of the table-of-contents information 108, the illustration table-of-contents information 105, and the product illustration link information 106 included in the electronic manual folder 42 corresponding to the individual manual database 44.

FIG. 17 is a diagram explaining a data structure example of the search table 304. The search table 304 is a table in which the correspondence relation among a Navi ID, a keyword, and a text body is recorded for each Navi ID. In the search table 304, a keyword included in “Head”, a Navi ID included in the “Head”, and content (a text body) of “Body” described in a range from immediately after the “Head” to immediately before the next “Head” are recorded in association with one another. Note that the search ID is an ID for identifying respective entries registered in the search table 304.

The operation of the electronic-manual display apparatus 1 configured as described above is described here. Note that, in the description, it is assumed that an operation entity is the electronic-manual display apparatus 1. However, in reality, the arithmetic unit 11 realizes each of the kinds of processing on the basis of control performed by the viewer program 41.

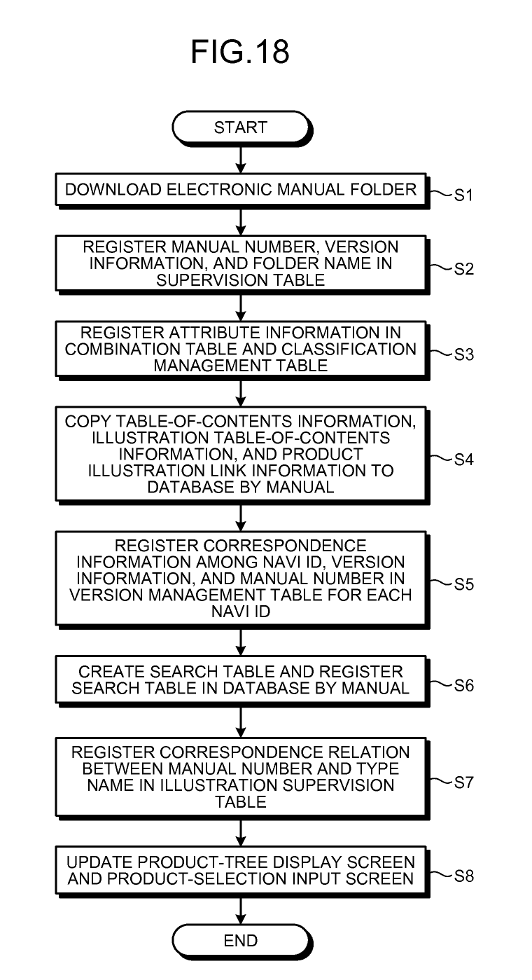

FIG. 18 is a flowchart explaining registration processing of an electronic manual. The registration processing is started by being triggered by various kinds of processing. As an example, in the following description, the registration processing is started by being triggered by an input from the user of an instruction to designate and download a desired electronic manual. Other examples of the trigger for the start of the registration processing are described below. The electronic-manual display apparatus 1 transfers (downloads) a designated electronic manual folder 42 from the electronic manual folder group 52 of the server 2 to the nonvolatile storage device 13 (step S1). Note that it is assumed that the transfer source is the server 2. However, a storage medium in which the electronic manual folder group 52 is stored in advance can be the transfer source. In such a case, the electronic-manual display apparatus 1 can execute the registration processing even if the electronic-manual display apparatus 1 is not connected to the network 3. Subsequently, the electronic-manual display apparatus 1 registers the manual number 101, the version information 102, and a folder name described in a full path of the downloaded electronic manual folder 42 in the supervision table 201 (step S2). In such a case, the electronic-manual display apparatus 1 numbers anew a supervision ID of the entries registered at step S2 and sets the status of the registered entries to “1 (valid)”. Note that, when entries having different version information 102 (entries having different version information 102 and the same manual number 101) are already registered, the electronic-manual display apparatus 1 sets the status of the already-registered entries to “0 (invalid)”.

Subsequently, the electronic-manual display apparatus 1 registers the content of the attribute information 104 included in the downloaded electronic manual folder 42 between the combination table 202 and the classification management table 203 (step S3). Specifically, the electronic-manual display apparatus 1 registers, in the combination table 202, a correspondence relation among a separate volume group ID, separate volume listing order, and a supervision ID in information included in the attribute information 104. When registering an entry in the combination table 202, the electronic-manual display apparatus 1 generates a combination ID anew and registers the combination ID. The electronic-manual display apparatus 1 registers, in the classification management table 203, a correspondence relation among a series name, a unit name, a model name, and a type name of a product included in the attribute information 104. In such a case, the electronic-manual display apparatus 1 numbers anew a classification ID of the entry registered anew. The electronic-manual display apparatus 1 stores, in a field of the combination ID of the classification management table 203, a combination ID corresponding to the combination ID in the entry registered anew in the combination table 202. The electronic-manual display apparatus 1 stores, in a field of the supervision ID of the classification management table 203, a supervision ID corresponding to the supervision ID in the entry registered anew at step S1.

Subsequently, the electronic-manual display apparatus 1 duplicates the table-of-contents information 108, the illustration table-of-contents information 105, and the product illustration link information 106 included in the downloaded electronic manual folder 42 and registers the duplicated respective kinds of information in the individual manual database 44 (step S4). The electronic-manual display apparatus 1 registers, for each Navi ID registered in the manual structure data 103 included in the downloaded electronic manual folder, a correspondence relation among the Navi ID, the version information 102, and the manual number 101 in the version management table 205 (step S5). The electronic-manual display apparatus 1 creates the search table 304 on the basis of the manual structure data 103 included in the downloaded electronic manual folder 42 and registers the created search table 304 in the individual manual database 44 (step S6). The search table 304 is created according to, for example, a procedure described below. That is, “Head” and “Body” located at the top among “Bodies” following the “Head” are extracted as a pair. A Navi ID and a keyword are extracted from the “Head”. The extracted ID and the extracted keyword are registered in one entry of the search table 304 in association with a text body described in the “Body”.

Following the processing at step S6, the electronic-manual display apparatus 1 registers a correspondence relation between the manual number 101 and a type name (in the illustration supervision table 204 (step S7). Specifically, the electronic-manual display apparatus 1 can read, from the illustration table-of-contents information 105 included in the downloaded electronic manual folder 42, a type name corresponding to the product illustration image 107 included in the electronic manual folder 42 and register the read-out type name and the manual number 101 included in the electronic manual folder 42 in the illustration supervision table 204 in association with each other.

Subsequently, the electronic-manual display apparatus 1 updates the product-tree display screen 1004 and the product-selection input screen 1012 on the basis of the classification management table 203 updated by the processing at step S3 (step S8) and ends the registration processing. Note that, on the product-tree display screen 1004 and the product-selection input screen 1012, a series name, a unit name, and a model name are in a tree-display for each type name. The tree display is realized, for example, as described below. First, the electronic-manual display apparatus 1 extracts a valid entry referring to the supervision table 201. The electronic-manual display apparatus 1 searches through the classification management table 203 using a supervision ID of the extracted entry as the search key. The electronic-manual display apparatus 1 displays a combination of a series name, a unit name, a model name, and a type name described in entries of the searched classification management table 203. When displaying a plurality of items related to entries in a common category on the high order side, the electronic-manual display apparatus 1 displays each of the items such that the portion of which category is common is collectively made one row and the portions of which category are different are divided into other rows as making a branch that branches from the different portions. Thus, the tree display is completed. In the processing at step S7, the tree display is updated according to the update of the classification management table 203.

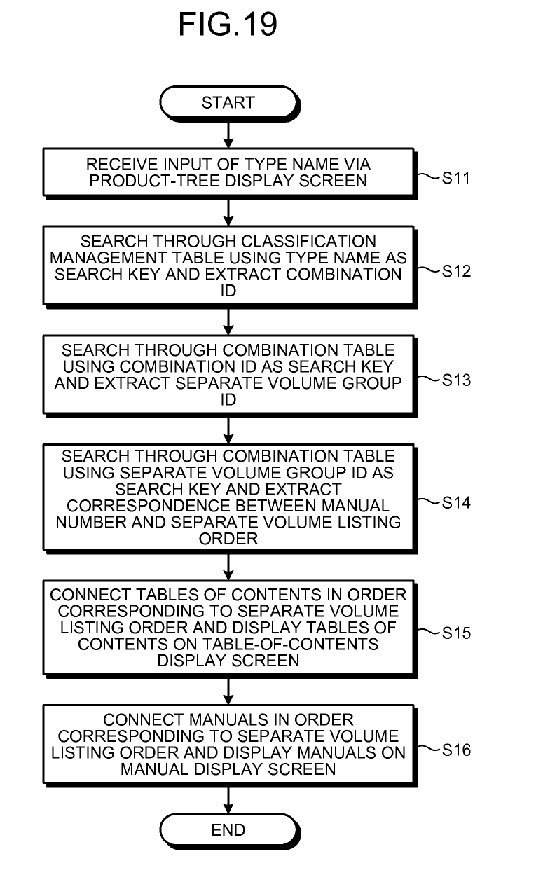

FIG. 19 is a flowchart explaining the operation of the electronic-manual display apparatus 1 performed when an input for designating a type name is received from the product-tree display screen 1004. As illustrated in the figure, when receiving an input of a type name via the product-tree display screen 1004 (step S11), the electronic-manual display apparatus 1 searches through the classification management table 203 using the designated type name as a search key (step S12) and extracts a combination ID (step S12). The electronic-manual display apparatus 1 searches through the combination table 202 using the extracted combination ID as a search key and extracts a separate volume group ID (step S13). The electronic-manual display apparatus 1 searches through the combination table 202 using the extracted separate volume group ID as a search key and extracts an association between the manual number 101 and separate volume listing order (step S14). The electronic-manual display apparatus 1 connects, in an order corresponding to the obtained separate volume listing order, the table-of-contents information 108 included in the electronic manual folders 42 respectively specified by an obtained one or more manual numbers 101 and displays the table-of-contents information 108 on the table-of-contents display screen 1007 (step S15). The electronic-manual display apparatus 1 connects, in the order corresponding to the obtained separate volume listing order, the manual displays 1000 based on the manual structure data 103 included in the electronic manual folders 42 respectively specified by the obtained one or more manual numbers 101 and displays the manual displays 1000 on the manual display screen 1005 (step S16). The electronic-manual display apparatus 1 ends the operation performed when the input for designating the type name is received.

Note that the electronic-manual display apparatus 1 can be configured to, when a desired heading is selected by, for example, a pointing device from the table of contents displayed on the table-of-contents display screen 1007, jump a display position in the manual display 1000 displayed on the manual display screen 1005 to a page corresponding to the selected heading. For this purpose, for example, the electronic-manual display apparatus 1 is configured as described below. That is, in the table-of-contents information 108, for each heading displayed as a table of contents, the heading and a Navi ID described in “Head” following immediately after the heading are described in advance. Alternatively, the table-of-contents information 108 can be configured by the Navi ID described in the “Head” immediately after the heading displayed as the table of contents. The electronic-manual display apparatus 1 can generate display content of the table-of-contents display screen 1007 on the basis of the Navi ID described in the table-of-contents information 108. When one heading in the displayed table of contents is selected, the electronic-manual display apparatus 1 reads a Navi ID corresponding to the selected heading from the table-of-contents information 108 and displays, in a frame of the manual display screen 1005, a position specified by the read-out Navi ID in the manual display 1000.

Note that, in the following description, processing at steps S12 to S16 is referred to as display processing.

As described above, when receiving an input for designating a product from the user, the electronic-manual display apparatus 1 automatically specifies the electronic manual folder 42 that describes the product; and when there are a plurality of the specified electronic manual folders 42, it displays the manual display 1000 on the basis of the manual structure data 103 stored in the specified electronic manual folders 42 on the manual display screen 1005. Consequently, the electronic-manual display apparatus 1 is capable of omitting work for specifying the electronic manual folder 42 of a product desired by the user among the electronic manual folders 42-1 to 42-n. Therefore, the electronic-manual display apparatus 1 can easily display content desired by the user from among an electronic manual group. When a plurality of the electronic manual folders 42 are specified, the electronic-manual display apparatus 1 displays the manual displays 1000 related to the specified electronic manual folders 42 on one manual display screen 1005 in association with one another. Therefore, it is possible to improve visibility compared with when the manual displays 1000 related to the electronic manual folders 42 are respectively displayed on different screens. That is, the electronic-manual display apparatus 1 can clearly display the content desired by the user among the electronic manual group.

When a plurality of the electronic manual folders 42 are specified, the electronic-manual display apparatus 1 displays tables of contents of the manual displays 1000 related to the respective electronic manual folders 42 on the table-of-contents display screen 1007 in association with one another. Consequently, by viewing the table-of-contents display screen 1007, the user can easily grasp the contents of the plurality of the manual displays 1000 displayed on the manual display screen 1005 in association with one another.

The electronic-manual display apparatus 1 displays a list of products, which are described by the electronic manual folders 42-1 to 42-n, on the product-tree display screen 1004 to enable the user to select individual products. The electronic-manual display apparatus 1 can receive an input for selecting a product via the product-tree display screen 1004. Consequently, the user is capable of selecting a product desired to be displayed without the necessity of typing the type name of the product.

The products are classified into categories in a hierarchical structure in the order of series name, unit name, model name, and type name. The electronic-manual display apparatus 1 displays the list of products in a tree display according to the hierarchical structure of the categories. Consequently, the electronic-manual display apparatus 1 can improve the visibility of the product-tree display screen 1004. As a result, the user is capable of easily finding and selecting a product, or an electronic manual that the user desires to be displayed, from the product-tree display screen 1004. Note that a display form of the product-tree display screen 1004 is not limited to only the form of a tree display. The display form of the product-tree display screen 1004 can be in the form of a list display.

The engineering tool includes, as system configuration information, a list of the type names of units from which a PLC is configured. Alternatively, the engineering tool can extract the system configuration information from the PLC connected to the engineering tool. That is, the engineering tool can output the PLC system configuration information. The electronic-manual display apparatus 1 can receive an input of the system configuration information from the engineering tool and automatically display the manual display 1000 concerning the units described in the input system configuration information.

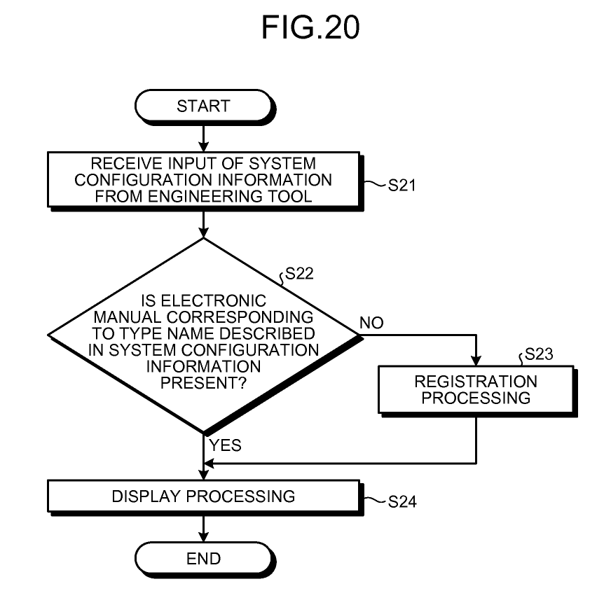

FIG. 20 is a flowchart explaining the operation of the electronic-manual display apparatus 1 performed when the system configuration information is input. When receiving an input of the system configuration information from the engineering tool (step S21), the electronic-manual display apparatus 1 determines whether an electronic manual corresponding to a type name described in the received system configuration information is present (step S22). Note that the electronic-manual display apparatus 1 searches through the classification management table 203 using a type name as the search key. When a valid entry is extracted from the classification management table 203, the electronic-manual display apparatus 1 can determine that the electronic manual corresponding to the type name is present. When the electronic manual corresponding to the type name described in the system configuration information is not present (No at step S22), the electronic-manual display apparatus 1 sets the electronic manual having the type name, the electronic manual corresponding to which is determined as not present, as a download target and executes the registration processing illustrated in FIG. 18 (step S23). When the electronic manual corresponding to the type name described in the system configuration information is present (Yes at step S22) or after the processing at step S23, the electronic-manual display apparatus 1 assumes that the type name described in the system configuration information is designated and executes the display processing illustrated in FIG. 19 (step S24). The electronic-manual display apparatus 1 ends the operation performed when the system configuration information is input.

As described above, the electronic-manual display apparatus 1 automatically searches through one or more electronic manuals related to all the products from which the PLC is configured on the basis of the system configuration information output by the engineering tool and connects and displays the found electronic manuals. The user can display the electronic manuals related to the products from which the PLC is configured without performing the task of checking the type names of the products from the PLC is configured every time and inputting the found type names to the electronic-manual display apparatus 1 every time.

When the electronic manual folder 42, which describes the products from which the PLC is configured, is not present locally (not in the nonvolatile storage device 13), the electronic-manual display apparatus 1 automatically downloads the pertinent electronic manual folder 42 from the server 2. Therefore, it is possible for the user not to perform the tasks of instructing registration of the locally not present electronic manual folder 42.

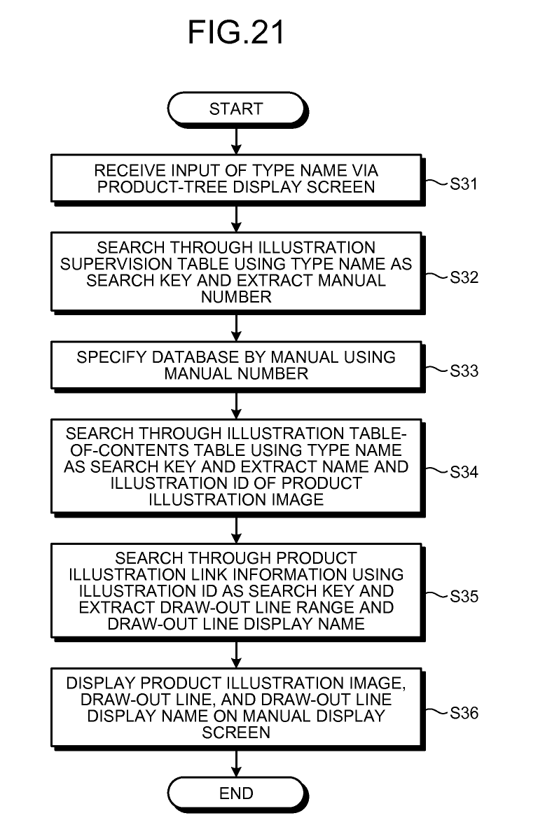

FIG. 21 is a flowchart explaining the operation of the electronic-manual display apparatus 1 when displaying the illustration 1008 (the product illustration image 107). Note that an event serving as a trigger for performing the display of the illustration 1008 is not limited to a particular trigger. For example, when it is set in advance which of the manual display 1000 and the illustration 1008 is preferentially displayed on the manual display screen 1005 and an input for designating a type name is received via the product-tree display screen 1004, the electronic-manual display apparatus 1 can perform displaying corresponding to this setting.

In FIG. 21, when receiving an input of a type name via the product-tree display screen 1004 (step S31), the electronic-manual display apparatus 1 searches through the illustration supervision table 204 using the designated type name as a search key and extracts the manual number 101 (step S32). The electronic-manual display apparatus 1 specifies the individual manual database 44 using the extracted manual number (step S33). The electronic-manual display apparatus 1 searches through the illustration table-of-contents information 302 included in the specified individual manual database 44 using the type name as the search key and extracts the name and the illustration ID of the product illustration image 107 (step S34). The electronic-manual display apparatus 1 searches through the product illustration link information 303 using the illustration ID as the search key and extracts a draw-out line range and a draw-out line display name (step S35). The electronic-manual display apparatus 1 displays, on the manual display screen 1005, the product illustration image 107 specified by the name extracted by the processing at step S34 and the draw-out line and the draw-out line display name extracted by the processing at step S35 (step S36). The electronic-manual display apparatus 1 ends the processing for displaying the product illustration image 107.

As described above, the electronic-manual display apparatus 1 can display the product illustration image 107 related to the selected product on the manual display screen 1005. Consequently, it is possible to reduce the burden on the user of finding an illustration related to a desired product from a quantity of electronic manual data.

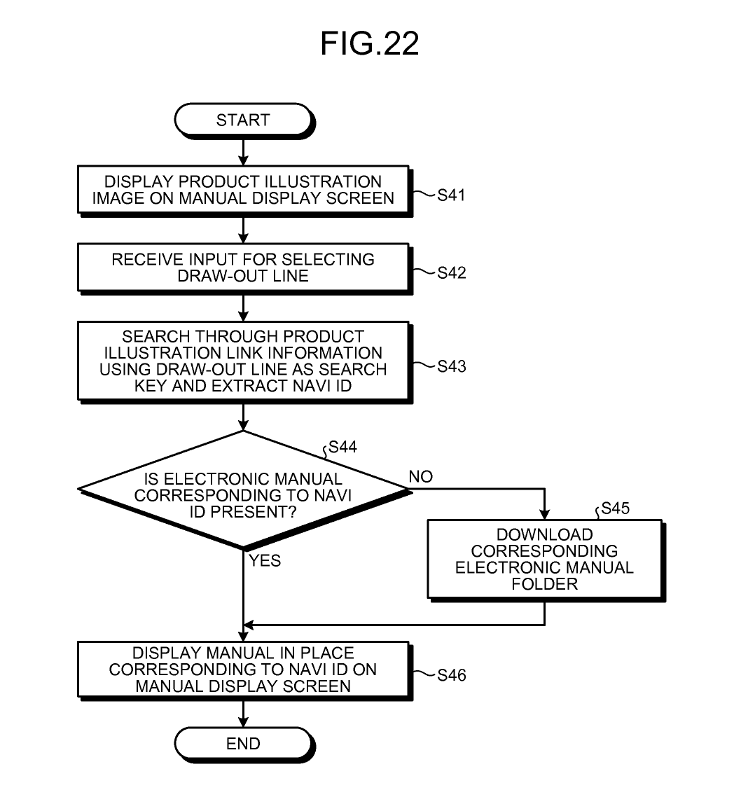

FIG. 22 is a flowchart explaining the operation of the electronic-manual display apparatus 1 performed when an input for selecting a draw-out line is received. First, the electronic-manual display apparatus 1 is displaying the illustration 1008 (the product illustration image 107) on the manual display screen 1005 (step S41). The user can perform an input for selecting a draw-out line, a draw-out line display name, or a draw-out line range using the pointing device or the like on the manual display screen 1005. When the draw-out line display name or the draw-out line range is selected, a draw-out line corresponding to the selected draw-out line display name or the selected draw-out line range is selected. Note that a correspondence relation between the draw-out line display name or the draw-out line range and the draw-out line is recorded in the product illustration link information 303. When receiving an input for selecting a draw-out line (step S42), the electronic-manual display apparatus 1 searches through the product illustration link information 303 using the draw-out line as the search key and extracts a Navi ID (step S43). The electronic-manual display apparatus 1 determines whether an electronic manual corresponding to the extracted Navi ID is present (step S44). It is possible to determine, by searching through the version management table 205 while using the Navi ID as the search key, whether an electronic manual corresponding to the Navi ID is present. That is, when the manual number 101 is extracted, the electronic-manual display apparatus 1 can determine whether the electronic manual corresponding to the Navi ID is present. When the manual number 101 cannot be extracted, the electronic-manual display apparatus 1 determines that the electronic manual corresponding to the extracted Navi ID is not present. When the electronic manual corresponding to the extracted Navi ID is not present (No at step S44), the electronic-manual display apparatus 1 downloads the electronic manual folder 42 corresponding to the electronic manual (step S45). Note that the electronic-manual display apparatus 1 specifies the download-target electronic manual folder 42 by searching through the version management table 51 stored in the server 2 using the Navi ID as a search key and extracting the manual number 101 corresponding to the Navi ID. When the electronic manual corresponding to the extracted Navi ID is present (Yes at step S44) or after the processing at step S45, the electronic-manual display apparatus 1 displays a place corresponding to the extracted Navi ID in a frame of the manual display screen 1005 (step S46). The electronic-manual display apparatus 1 ends the operation performed when the draw-out line is selected.

As described above, the electronic-manual display apparatus 1 displays the partial region (the region of attention 1009, the draw-out line 1010, and the explanatory note 1011) on the illustration 1008 displayed on the manual display screen 1005. When the partial region is selected, the electronic-manual display apparatus 1 calculates, on the basis of the product illustration link information 303, a Navi ID corresponding to the selected partial region and displays, in the frame of the manual display screen 1005, a part specified by the Navi ID in the manual display 1000 by the manual structure data 103 in which the calculated Navi ID is recorded. Consequently, the user is capable of specifying and displaying, with a simple operation, an electronic manual related to a function of a product.

Note that, in the above description, for each of the draw-out lines 1010, the Navi ID is associated with the draw-out line 1010 as position information of a reference destination. However, the position information of the reference destination can be associated with a text body. Specifically, for example, a Navi ID for specifying a position of a link destination is embedded in a part of words forming a text body described in “Body”. When displaying, on the manual display screen 1005, the word (or a display object) in which the Navi ID is embedded, the electronic-manual display apparatus 1 performs a highlighted display (link destination display) indicating that the link destination is present, for example, it displays the word (or the display object) in a color different from the color of the other places. The user is capable of selecting the link destination display using the pointing device. When the link destination display is selected, the electronic-manual display apparatus 1 calculates the Navi ID embedded in the display place of the link destination display. The electronic-manual display apparatus 1 can display a place corresponding to the extracted Navi ID in the frame of the manual display screen 1005 by executing processing the same as the processing at steps S44 to S46.

After calculating the Navi ID corresponding to the partial region, the electronic-manual display apparatus 1 determines whether the electronic manual folder 42 including the manual structure data 103, in which the calculated Navi ID is recorded, is locally present. When the relevant electronic manual folder 42 is not locally present, the electronic-manual display apparatus 1 downloads the relevant electronic manual folder 42 from the server 2. Consequently, even if a manual related to a desired function is not stored in the electronic-manual display apparatus 1, the user is capable of displaying the relevant manual without performing the task of specifying and downloading the manual.

The user can search for an electronic manual in a state in which the traverse search tab 1003 is selected and the viewer screen 1001 illustrated in FIG. 4 is displayed. That is, the user can select a search-target type name on the product-selection input screen 1012. Note that the user is capable of selecting, by selecting a higher order category, one or more type names belonging to the category at a time. The user is also capable of selecting a plurality of type names by checking a plurality of check boxes. The user can also narrow down search targets by inputting a keyword to the keyword input screen 1013.

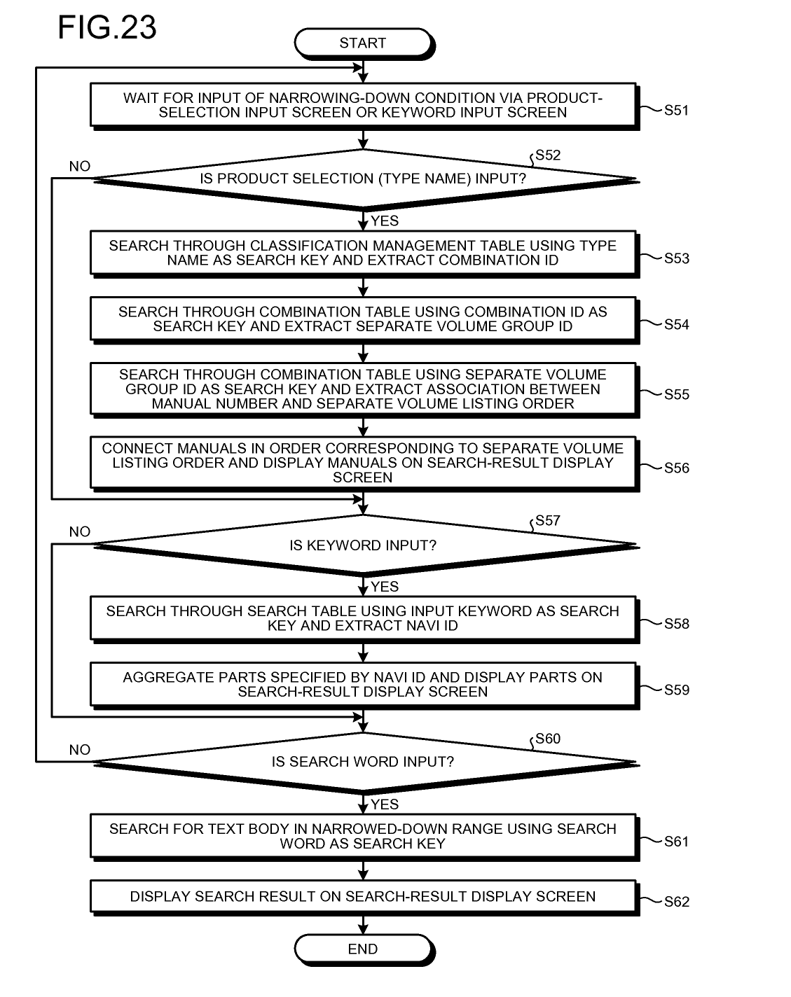

FIG. 23 is a flowchart explaining the operation of the electronic-manual display apparatus 1 during a search. First, the electronic-manual display apparatus 1 waits for an input of a narrowing-down condition via the product-selection input screen 1012 or the keyword input screen 1013 (step S51). The electronic-manual display apparatus 1 determines whether an input of a type name is received (step S52). When the input of the type name is received (Yes at step S52), the electronic-manual display apparatus 1 searches through the classification management table 203 using the input type name as a search key and extracts a combination ID(step S53). The electronic-manual display apparatus 1 searches through the combination table 202 using the extracted combination ID as a search key and extracts a separate volume group ID (step S54). The electronic-manual display apparatus 1 searches through the combination table 202 using the extractive separate volume group ID as the search key and extracts the association of the manual number 101 and the separate volume listing order (step S55). The electronic-manual display apparatus 1 connects, in order corresponding to the obtained separate volume listing order, the manual displays 1000 based on the manual structure data 103 included in the electronic manual folders 42 respectively specified by obtained one or more manual numbers 101 and displays the manual displays 1000 on the search-result display screen 1015 (step S56). Note that, at step S56, to clearly show a search range, the manual display 1000 can be abbreviated and displayed by, for example, reducing the length of a text body for each heading.

When the input of the type name is not received (No at step S52) or after the processing at step S56, the electronic-manual display apparatus determines whether an input of a keyword via the keyword input screen 1013 is received (step S57). When the input of the keyword is received (Yes at step S57), the electronic-manual display apparatus 1 searches through the search table 304 using the keyword as the search key and extracts a Navi ID (step S58). Note that, when the processing at step S56 is applied, the search-target search table 304 in the processing at step S58 is the search table 304 included in one or more electronic manual folders 42 specified by the manual number 101 extracted by the processing at step S55. After the processing at step S58, the electronic-manual display apparatus 1 aggregates parts specified by the extracted Navi ID and displays the manual display 1000 on the search-result display screen 1015 (step S59).

When the input of the keyword is not received (No at step S57) or after the processing at step S59, the electronic-manual display apparatus 1 determines whether an input of a search word via the search-word input screen 1014 is received (step S60). When the input of the search word is received (Yes at step S60), the electronic-manual display apparatus 1 searches through the text body registered in the search table 304 using the input search word as the search key (step S61). A search range at step S61 is a text body associated with the Navi ID extracted by the input of the keyword in the search table 304 included in the electronic manual folder 42 specified by the input of the type name. When the input of the search word is not received (No at step S60), the electronic-manual display apparatus 1 executes the processing at step S51 again. After the processing at step S61, the electronic-manual display apparatus 1 displays a search result on the search-result display screen 1015 (step S62) and ends the operation during the search. At step S62, the text body including the search word is reduced in length and displayed for each heading.

Note that when the input of the type name is not received and the input of the keyword is received, the electronic-manual display apparatus 1 can set, as the search range at step S61, the text body corresponding to the keyword in the search table 304 included in all the registered electronic manual folders 42. When the input of the type name is received and the input of the keyword is not received, the electronic-manual display apparatus 1 can set text bodies, as the search range in the processing at step S61, related to all the entries of the search table 304 included in the electronic manual folder 42 specified by the type name.

As described above, the electronic-manual display apparatus 1 narrows down the search range to the electronic manual corresponding to the selected product and performs a search through the text body. Consequently, the user is capable of causing the electronic-manual display apparatus 1 to not search for content related to an undesired product. The electronic-manual display apparatus 1 can improve search speeds by narrowing the search range.

When receiving the input of the keyword, the electronic-manual display apparatus 1 narrows the search range to a part specified by the input keyword and performs a search through the text body. Consequently, the user can narrow the search range to content related to the key word.

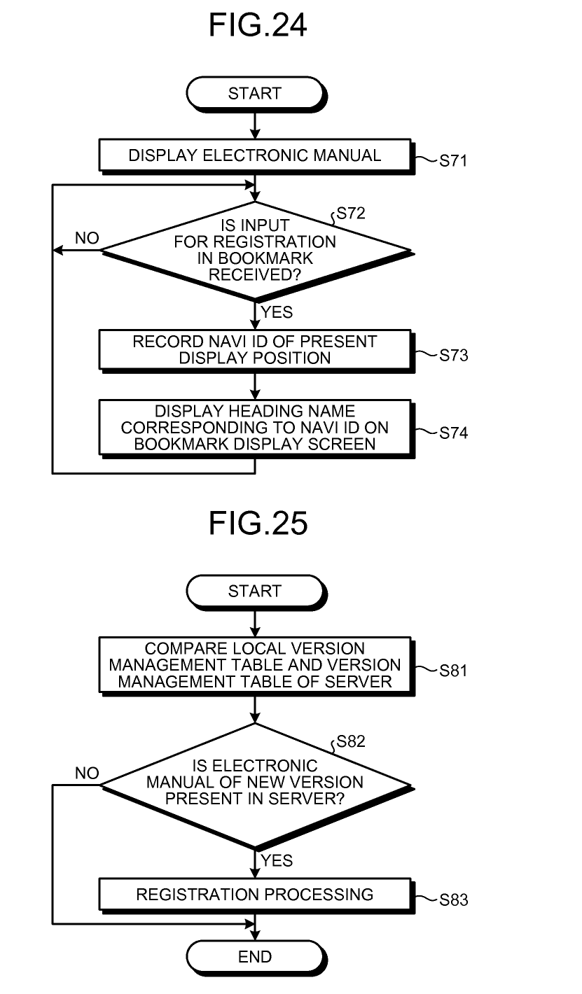

FIG. 24 is a flowchart explaining the operation of the electronic-manual display apparatus 1 performed when an input for registering a position on the manual display 1000 in a bookmark is received. The electronic-manual display apparatus 1 has a function of instantaneously moving a display position to a position recorded in advance in the manual display 1000. The electronic-manual display apparatus 1 displays a list of recorded positions on the bookmark display screen 1006. Recording a position is called “registering in a bookmark”. An operation for registering the display position in the bookmark is executed in a state in which the electronic-manual display apparatus 1 displays the manual display 1000 on the manual display screen 1005 (step S71). The electronic-manual display apparatus 1 determines whether an input for instructing registration in the bookmark is received in a state in which the display of the manual display 1000 is performed (step S72). Note that a form of the input for instructing the registration in the bookmark is not limited to a particular form. For example, while the manual display screen 1005 is displayed, the electronic-manual display apparatus 1 displays, on the viewer screen 1001, a display object that receives an input indicating registration in the bookmark. When the display object is pressed, the electronic-manual display apparatus 1 can recognize that the input for instructing the registration in the bookmark is received. When the input for instructing the registration in the bookmark is not received (No at step S72), the electronic-manual display apparatus 1 executes the determination processing at step S72 again. When the input for instructing the registration in the bookmark is received (Yes at step S72), the electronic-manual display apparatus 1 records, on the inside thereof, a Navi ID corresponding to a portion that fits within the frame of the manual display screen 1005 in the manual display 1000 (step S73). Note that, when a plurality of headings are displayed in the frame of the manual display screen 1005, the electronic-manual display apparatus 1 can record a Navi ID corresponding to any heading. For example, the electronic-manual display apparatus 1 can record a Navi ID corresponding to the heading displayed at the top among the headings displayed in the frame. When the user displays a cursor in the frame using the pointing device, the electronic-manual display apparatus 1 can record a Navi ID corresponding to the heading displayed right above a display position of the cursor or present outside the frame. Following the processing at step S73, the electronic-manual display apparatus 1 displays a heading name corresponding to the recorded Navi ID on the bookmark display screen 1006 (step S74) and executes the determination processing at step S72 again. When receiving an input for selecting one heading among the headings displayed on the bookmark display screen 1006, the electronic-manual display apparatus 1 displays, on the manual display screen 1005, a place specified by a Navi ID corresponding to the selected heading.

As described above, when receiving the input for the registration instruction while the manual display 1000 is displayed on the manual display screen 1005, the electronic-manual display apparatus 1 records the Navi ID corresponding to a position of the display and displays a heading corresponding to the recorded Navi ID on the bookmark display screen 1006. When receiving an input for selecting the heading displayed on the bookmark display screen 1006, the electronic-manual display apparatus 1 displays, on the manual display screen 1005, a place specified by the position control code corresponding to the selected heading. Consequently, the user is capable of recording a desired display position in advance and invoking the recorded display position with simple operation.

FIG. 25 is a flowchart explaining the operation of the electronic-manual display apparatus 1 for updating the electronic manual folder 42 to the latest version. Here, this operation is referred to as an update processing. First, the electronic-manual display apparatus 1 compares the version management table 205 stored in the nonvolatile storage device 13 (the local version management table 205) and the version management table 51 stored by the server 2 (the version management table 51 of the server 2) (step S81). The electronic-manual display apparatus 1 determines whether a new version of an electronic manual is present in the server 2 (step S82). Specifically, in the processing at step S81, the electronic-manual display apparatus 1 determines, for each manual number 101 registered in the local version management table 205, whether the version information 102 in the local version management table 205 and the version information 102 in the version management table 51 of the server 2 coincide with each other. When the manual number 101 in which the pieces of version information 102 do not coincide with each other is present, the electronic-manual display apparatus 1 determines that a new version of the electronic manual is present in the server 2. When the manual number 101 in which the pieces of version information 102 do not coincide with each other is not present, the electronic-manual display apparatus 1 determines that a new version of the electronic manual is not present in the server 2. When the electronic manual of the new version is present in the server 2 (Yes at step S82), the electronic-manual display apparatus 1 executes registration processing with the electronic manual folder 42 that is related to the new electronic manual to set a download target(step S83) and ends the update processing. The registration-target electronic manual folder 42 is specified using the manual number 101 in which the pieces of version information 102 do not coincide with each other. When the electronic manual of the new version is not present in the server 2 (No at step S82), the electronic-manual display apparatus 1 skips the processing at step S83.

As described above, the electronic-manual display apparatus 1 determines whether an electronic manual folder is stored in the server 2 that has the manual number 101 that is the same as the manual number 101 of the local electronic manual display folder 42 and also has the version information 102 that is different from the version information 102 of the local electronic manual display folder 42. When the electronic manual folder, having the manual number 101 that is the same as the manual number 101 of the local electronic manual display folder 42 and having the version information 102 that is different from the version information 102 of the local electronic manual display folder 42, is stored in the server 2, the electronic-manual display apparatus 1 downloads the electronic manual folder 42 from the server 2. Consequently, the user is capable of easily keeping the local electronic manual folder 42 in the latest version.

As described above, according to the first embodiment of the present invention, when receiving an input for designating a product from the user, the electronic-manual display apparatus 1 automatically specifies the electronic manual folder 42, which explains the product that is a target. When a plurality of the specified electronic manual folders 42 are present, the electronic-manual display apparatus 1 displays, on the manual display screen 1005, the manual displays 1000 based on the manual structure data 103 stored in the specified electronic manual folders 42. Consequently, the electronic-manual display apparatus 1 can easily and clearly display the contents desired by the user from among the electronic manual group.

In the above description, it is assumed that the Navi ID is recorded in the manual structure data 103 for each heading. However, a unit in which the Navi ID is recorded is not limited to each heading.

The electronic-manual display apparatus 1 is described as executing the operations by referring to the traverse management database 43 and the individual manual databases 44-1 to 44-n. The traverse management database 43 and the individual manual databases 44-1 to 44-n are configured by the entries generated on the basis of the manual number 101, the version information 102, the manual structure data 103, the attribute information 104, the illustration table-of-contents information 105, and the product illustration link information 106 included in the electronic manual folder 42. Therefore, the operation for referring to the traverse management database 43 and the individual manual databases 44-1 to 44-n is equal to the operation for referring to the manual number 101, the version information 102, the manual structure data 103, the attribute information 104, the illustration table-of-contents information 105, and the product illustration link information 106 included in the electronic manual folder 42. For example, the information obtained by searching through the combination table 202 and the classification management table 203 is also obtained by searching through the attribute information 104 included in the electronic manual folders 42-1 to 42-n. Note that, when the traverse management database 43 and the individual manual databases 44-1 to 44-n are built on the basis of the manual number 101, the version information 102, the manual structure data 103, the attribute information 104, the illustration table-of-contents information 105, and the product illustration link information 106 and information is extracted from the built databases, it is possible to obtain an effect where processing speed is improved compared with a case where information is extracted from the manual number 101, the version information 102, the manual structure data 103, the attribute information 104, the illustration table-of-contents information 105, and the product illustration link information 106.

The version management table 205 is described as being also used as the information for specifying, from a Navi ID, the manual structure data 103 in which the Navi ID is recorded (and the electronic manual folder 42 including the manual structure data 103) (e.g., step S44). However, because the Navi ID includes the manual number 101 in a part thereof, the electronic-manual display apparatus 1 can also specify the manual structure data 103 and the electronic manual folder 42 by reading the manual number 101 included in the Navi ID.

### Second Embodiment

According to a second embodiment, an electronic-manual display apparatus can function as a help manual for an engineering tool. The engineering tool can issue a display request using an event code as an argument. The event code is identification information of an event that occurs in the engineering tool. In the second embodiment, the electronic-manual display apparatus has stored therein a correspondence relation between the event code and a Navi ID in advance. When receiving the display request, the electronic-manual display apparatus can display, on the manual display screen 1005, a position corresponding to the event code received as the argument of the display request in the manual display 1000. The event code includes an error code that is identification information of an error that occurs in the engineering tool. The event code includes a help code, which is display-content identification information of a help manual.

The configuration of the electronic-manual display apparatus in the second embodiment is equivalent to the configuration in the first embodiment except for the configuration of the search table. Concerning components equivalent to the components, names, reference numerals, and signs in the first embodiment that are the same as the names, the reference numerals, and the signs in the second embodiment, redundant description is omitted.

According to the second embodiment, an event code is described in a field of a keyword embedded in the “Head” in description content of the manual structure data 103. When downloading the electronic manual folder 42 (step S1), the electronic-manual display apparatus 1 records the event code in the search table.

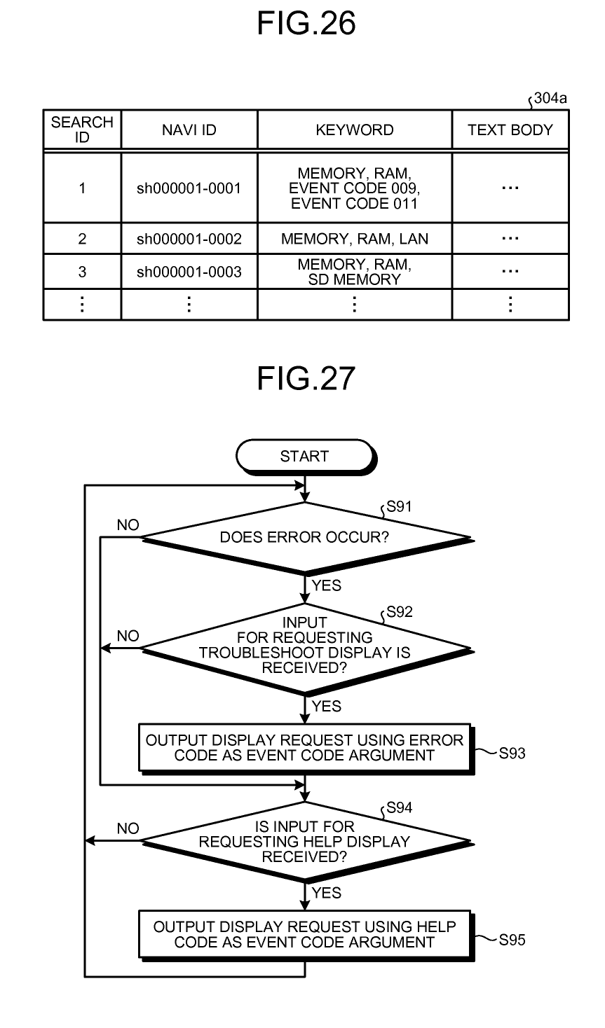

FIG. 26 is a diagram explaining a data configuration example of the search table in the second embodiment. As illustrated in the figure, an event code is registered in a field of a keyword of a search tale 304a. Consequently, the search tale 304a functions as event correspondence information in which a correspondence relation between the event code and a Navi ID is recorded.

The operation of the electronic-manual display apparatus 1 in the second embodiment is described here. Note that, it is assumed that, in the computer 1, both of the viewer program 41 and the engineering tool program 45 are being executed.

FIG. 27 is a flowchart explaining the operation of the engineering tool. The engineering tool determines whether an error occurs (step S91). When an error occurs (Yes at step S91), the engineering tool determines whether an input for requesting a troubleshoot display is received from a user (step S92).

For example, when an error occurs, the engineering tool can display content of the error on the output device 15. The engineering tool can receive the input requesting the troubleshoot display while displaying details of the arisen error. The form of the input for requesting the troubleshoot display is not limited to a particular form. For example, when the “F1” key included in a keyboard is pressed, the engineering tool can recognize it as an input requesting that the troubleshoot display be received. When the input requesting the troubleshoot display is received (Yes at step S92), the engineering tool outputs a display request using an error code for identifying the arisen error as an argument (step S93).

When an error does not occur (No at step S91), if the input for requesting troubleshoot display is not received (No at step S92), or after the processing at step S93, the engineering tool can receive an input requesting a help display. The form of the input requesting the help display can be any form. A help code is incidental to the input for requesting the held display. The engineering tool determines whether the input requesting the held display is received (step S94). When the input for requesting the help display is received (Yes at step S94), the engineering tool outputs a display request using the held code as an argument (step S95). When the input for requesting the held display is not received (No at step S94) or after the processing at step S95, the engineering tool executes the determination processing at step S91 again.

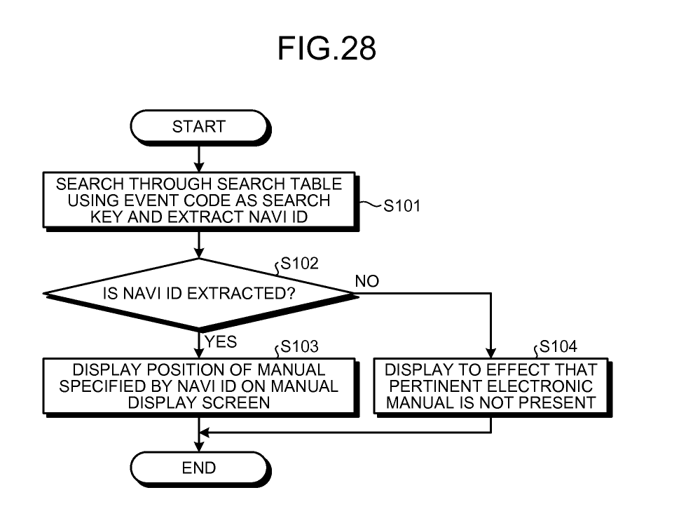

FIG. 28 is a flowchart explaining the operation of the electronic-manual display apparatus 1 performed when the display request is received. The electronic-manual display apparatus 1 searches through the search tables 304a included in all the registered electronic manual folders 42 using, as the search key, the event code received as the argument of the display request and extracts a Navi ID (step S101). The electronic-manual display apparatus 1 determines whether the Navi ID is extracted (step S102). When the Navi ID is extracted (Yes at step S102), the electronic-manual display apparatus 1 displays, in the frame of the manual display screen 1005, a position specified by the Navi ID in the manual display 1000 based on the manual structure data 103 specified by the Navi ID (step 5103) and ends the operation responding to the display request. When the Navi ID is not extracted (No at step S102), the electronic-manual display apparatus 1 displays an output to the effect that a pertinent electronic manual is not present and ends the operation responding to the display request.

In the above description, it is assumed that the display request is received by the electronic-manual display apparatus 1 while the computer 1 is operating as the electronic-manual display apparatus 1. The engineering tool determines whether the viewer program 41 is started. When the viewer program 41 is not started, the engineering tool can issue a display request after starting the viewer program 41. The engineering tool and the viewer program 41 can be configured such that the start code of the viewer program 41 can be used as the display request.

As described above, according to the second embodiment, the electronic-manual display apparatus 1 stores the event correspondence information in advance. When receiving the input of the event code output by the engineering tool, the electronic-manual display apparatus 1 calculates a Navi ID corresponding to the input event code by referring to the event correspondence information and displays a part specified by the calculated position control code on the manual display screen 1005. Consequently, while the user is operating the engineering tool, the electronic-manual display apparatus 1 can display an electronic manual corresponding to an operation without requiring a search by the user.

When an error occurs, the event code includes an error code corresponding to the error that has arisen. Consequently, the user can easily check the cause of the error. When an input for displaying help is received, the event code includes a help code corresponding to the display-target help manual to be displayed. Consequently, the burden of creating help manuals is reduced for engineering tool manufacturers.

### INDUSTRIAL APPLICABILITY

As described above, the program and the electronic-manual display apparatus according to the present invention are suitable to be applied to a program and an electronic-manual display apparatus that displays a digitized user manual.

### REFERENCE SIGNS LIST

1 Electronic-manual display apparatus (Computer)

2 Server

3 Network

11 Arithmetic unit

12 Volatile storage device

13 Nonvolatile storage device

14 Input device

15 Output device

16 Network interface

41 Viewer program

42, 42-1 to 42-n Electronic manual folders

43 Traverse management database

44, 441- to 44-n individual manual databases

45 Engineering tool program

51 Version management table

52 Electronic manual folder group

101 Manual number

102 Version information

103 Manual structure data

104 Attribute information

105 Illustration table-of-contents information

106 Product illustration link information

107 Product illustration image

108 Table-of-contents information

201 Supervision table

202 Combination table

203 Classification management table

204 Illustration supervision table

205 Version management table

301 Table-of-contents information

302 Illustration table-of-contents information

303 Product illustration link information

304, 304a Search tables

1000 Manual display

1001 Viewer screen

1002 Manual display tab

1003 Traverse search tab

1004 Product-tree display screen

1005 Manual display screen

1006 Bookmark display screen

1007 Table-of-contents display screen

1008 Illustration

1009 Region of attention

1010 Draw-out line

1011 Explanatory note

1012 Product-selection input screen

1013 Keyword input screen

1014 Search-word input screen

1015 Search-result display screen

1041 to 1046 Items

1. A computer-readable recording medium that stores therein a computer program that instructs a computer to execute:
a step of registering, in the storage device, data of a plurality of electronic manuals, each including text data of a product manual,
the electronic manual data including attribute information in which, for each product that is an explanation target of the electronic manual data, a correspondence relation between the product and a group ID is recorded;
a step of receiving, from an outside source, a first input for designating a product;
a step of extracting a group ID associated with the designated product from the attribute information in the electronic manual data stored in the storage device;
a step of specifying the electronic manual data including the attribute information in which the extracted group ID is recorded;
a step of displaying, when data of one electronic manual is specified, in a first region of a display device, text data included in the specified electronic manual data; and
a step of connecting, when data of a plurality of electric manuals is specified, text data included in the specified electronic manual data and displaying the text data in the first region.

2. The computer-readable recording medium according to claim 1, further causing the computer to execute
a step of displaying, on the basis of the attribute information and in a second region of the display device, a list of products, which are explanation targets of the text data included in the electronic manual data stored in the storage device, in such a manner that a user is able to select each of the products, wherein
the step of receiving the first input for designating a product from the outside source includes a step of receiving the first input via the second region.

3. The computer-readable recording medium according to claim 1, wherein
the first input is configuration information in which one or more products from which a control system is configured that is output by a setting tool for setting the control system are recorded.

4. The computer-readable recording medium according to claim 1, wherein
the data of at least one of the electronic manuals further includes
an illustration image of an explanation-target product of text data included in the electronic manual data and
illustration table-of-contents information in which a correspondence relation between the illustration image and the explanation-target product is recorded, and
the program further causes the computer to execute:
a step of specifying, on the basis of the illustration table-of-contents information included in the electronic manual data stored in the storage device, an illustration image of the product designated by the first input; and
a step of displaying the specified illustration image in a third region.

5. The computer-readable recording medium according to claim 4, wherein
in the text data, a position control code peculiar at least in a range of all the electronic manual data stored in the storage device is recorded for each predetermined unit,
all of the electronic manual data including the illustration image further includes, for each illustration image included in the electronic manual data, illustration link information in which a correspondence relation between a definition of a partial region and a position control code of text data included in the electronic manual data or the other electronic manual data is recorded, and
the program further causes the computer to execute:
a step of displaying the partial region on the illustration image displayed in the third region in such a manner that a user is able to select the partial region; and
a step of
calculating, when the user selects the partial region via the illustration image displayed in the third region, a position control code corresponding to the selected partial region on the basis of the illustration link information and
displaying, in a frame of the first region, a part specified by the calculated position control code in text data in which the calculated position control code is recorded.

6. The computer-readable recording medium according to claim 5, wherein
the text data includes a link destination display associated with a position control code of a link destination, and
the program further causes the computer to execute:
a step of receiving an input for selecting the link destination display included in the text data displayed in the first region;
a step of calculating, on the basis of the displayed text data, the position control code of the link destination corresponding to the selected link destination display; and
a step of displaying, in the frame of the first region, a part specified by the calculated position control code of the link destination in the text data in which the calculated position control code of the link destination is recorded.

7. The computer-readable recording medium according to claim 2, further comprising causing the computer to execute:
a step of receiving an input of a search word; and
a step of
narrowing a search range to the text data included in the data of the specified one or more electronic manuals and
searching for the input search word.

8. The computer-readable recording medium according to claim 7, wherein
in the text data, a keyword is recorded for each of the predetermined units, and
the program further causes the computer to execute:
a step of receiving a second input for inputting the keyword; and
a step of further
narrowing the search range to a part specified by the input keyword and
searching for the input search word.

9. The computer-readable recording medium according to claim 1, wherein
the data of each of the plurality of electronic manuals includes
a manual number for identifying the electronic manual data and
version information of the electronic manual data, and
the program further causes the computer to execute:
a step of communicating with a server that stores latest versions of the data of the plurality of electronic manuals; and
a step of downloading, when the server stores therein electronic manual data having a same manual number and different kinds of version information among the data of the plurality of electronic manuals stored in the storage device, the electronic manual data to the storage device.

10. The computer-readable recording medium according to claim 5, further causing the computer to execute:
a step of communicating with a server that stores electronic manual data larger in amount than the electronic manual data stored in the storage device; and
a step of
determining whether first electronic manual data including the text data, in which the calculated position control code is recorded, is stored in the storage device and
downloading the first electronic manual data from the server when the first electronic manual data is not stored in the storage device.

11. The computer-readable recording medium according to claim 6, further causing the computer to execute:
a step of communicating with a server that stores therein electronic manual data larger in amount than the electronic manual data stored in the storage device; and
a step of
determining whether second electronic manual data including the text data, in which the calculated position control code of the link destination is recorded, is stored in the storage device and
downloading the second electronic manual data from the server when the second electronic manual data is not stored in the storage device.

12. The computer-readable recording medium according to claim 10, wherein
each of the data of a plurality of electronic manuals stored in the storage device and the data of a plurality of electronic manuals stored in the server includes a manual number for identifying the electronic manual data,
each of the position control codes includes, in a part thereof, a manual number for identifying the electronic manual data including text data in which the position control code is recorded, and
the program further causes the computer to execute a step of specifying the first electronic manual data on the basis of the manual number included in the calculated position control code.

13. The computer-readable recording medium according to claim 11, wherein
each of a plurality of electronic manual data stored in the storage device and a plurality of electronic manual data stored in the server includes a manual number for identifying the electronic manual data,
each of the position control codes includes, in a part thereof, a manual number for identifying the electronic manual data including text data in which the position control code is recorded, and
the program further causes the computer to execute a step of specifying the second electronic manual data on the basis of the manual number included in the calculated position control code.

14. The computer-readable recording medium according to claim 2, wherein
the products are classified into categories forming a hierarchical structure of a plurality of layers,
in the attribute information, the category to which an explanation-target product belongs is recorded for each of the products, and
the step of displaying the list of the products in the second region of the display device such that the user is able to select each of the products includes a step of displaying the list of the products as a tree in the second region according to the hierarchical structure.

15. The computer-readable recording medium according to claim 1, wherein
in the attribute information, a connection number is recorded in association with a group ID recorded in the attribute information, and
the program further causes the computer to execute a step of connecting, in an order corresponding to the connection number, the text data included in the data of the plurality of specified electronic manuals.

16. The computer-readable recording medium according to claim 1, wherein
the data of each of the plurality of electronic manuals further includes table-of-contents information in which a table of contents corresponding to the text data included in the electronic manual data is recorded, and
the program further causes the computer to execute a step of
connecting, when the data of a plurality of electronic manuals is specified, tables of contents recorded in the table-of-contents information respectively included in the data of the plurality of specified electronic manuals and
displaying the tables of contents in a fourth region of the display device.

17. The computer-readable recording medium according to claim 1, wherein
in all of the text data, a position control code peculiar at least in a range of all the electronic manual data stored in the storage device is recorded for each heading, and
the program further causes the computer to execute:
a step of receiving an input of a bookmark registration instruction while the text data is displayed in the first region;
a step of
recording, when the input of the bookmark registration instruction is received, a position control code corresponding to a display position in a frame of the first region among the position control codes recorded in the displayed text data and
displaying, in a fifth region, a heading corresponding to the recorded position control code;
a step of receiving an input for selecting the heading displayed in the fifth region; and
a step of displaying, when the input for selecting the heading is received, in the frame of the first region, a part specified by the selected position control code in the text data in which the position control code corresponding to the selected heading is recorded.

18. The computer-readable recording medium according to claim 3, further causing the computer to execute:
a step of communicating with a server that stores therein electronic manual data larger in amount than the electronic manual data stored in the storage device; and
a step of
determining, on the basis of the attribute information included in the electronic manual data stored in the storage device, whether third electronic manual data, an explanation target of which is the designated product, is stored in the storage device and
downloading, when the third electronic manual data is not stored in the storage device, the third electronic manual data from the server.

19. The computer-readable recording medium according to claim 3, wherein
the setting tool outputs an event code at a predetermined timing,
in the text data, a position control code peculiar at least in a range of all the electronic manual data stored in the storage device is recorded for each predetermined unit,
the storage device stores therein in advance event correspondence information in which a correspondence relation between the position control code and the event code is recorded, and
the program further causes the computer to execute:
a step of receiving an input of the event code output by the setting tool;
a step of calculating a position control code corresponding to the input event code that is input by referring to the event correspondence information; and
a step of displaying, in a frame of the first region, a part specified by the calculated position control code in the text data in which the calculated position control code is recorded.

20. The computer-readable recording medium according to claim 19, wherein,
when an error occurs, the setting tool outputs an event code corresponding to the error that has occurred.

21. The computer-readable recording medium according to claim 19, wherein,
when an input for displaying help is received, the setting tool outputs an event code corresponding to the display-target help.

22. An electronic-manual display apparatus comprising:
a storage device that stores data of a plurality of electronic manuals, each including text data of a manual of a product; and
an arithmetic unit that displays the text data on a display device, wherein
the data of each of the plurality of electronic manuals further includes attribute information in which, for each product that is an explanation target of the electronic manual data, a correspondence relation between the product and a group ID is recorded, and
the arithmetic unit, when receiving a first input for designating a product from an outside source,
extracts a group ID associated with the designated product from the attribute information of the data of the plurality of electronic manuals stored in the storage device,
specifies the electronic manual data including the attribute information in which the extracted group ID is recorded,
displays, when the data of one electronic manual is specified, in a first region of the display device, text data included in the data of the specified one electronic manual, and
connects, when the data of a plurality of electronic manuals is specified, text data included in the data of the specified plurality of electronic manuals and displays the text data in the first region.

23. A method of electronic-manual display, comprising:
a step of registering, in a storage device, data of a plurality of electronic manuals, each including text data of a product manual, the electronic manual data including attribute information in which, for each product that is an explanation target of the electronic manual data, a correspondence relation between the product and a group ID is recorded;
a step of receiving, from an outside source, a first input for designating a product;
a step of extracting a group ID associated with the designated product from the attribute information in the electronic manual data stored in the storage device;
a step of specifying the electronic manual data including the attribute information in which the extracted group ID is recorded;
a step of displaying, when data of one electronic manual is specified, in a first region of a display device, text data included in the specified electronic manual data; and
a step of connecting, when data of a plurality of electric manuals is specified, text data included in the specified electronic manual data and displaying the text data in the first region.
